(19) United States
(12) Patent Application Publication
(10) Pub. No.: US 2026/0340895 A1
(43) Pub. Date: Oct. 29, 2026

(54) UTILIZING A MULTIMODAL LARGE LANGUAGE MODEL FOR ESTIMATING, HALLUCINATING, AND REPOSING HUMAN POSES IN DIGITAL IMAGES

(71) Applicant: Adobe Inc., San Jose, CA (US)

(72) Inventors: Connelly Barnes, Seattle, WA (US); Yuqian Zhou, Seattle, WA (US); Sohrab Amirghodsi, Seattle, WA (US); Lingzhi Zhang, Philadelphia, PA (US); Katherine Xu, Philadelphia, PA (US); Elya Shechtman, Seattle, WA (US)

(21) Appl. No.: 19/191,166

(22) Filed: Apr. 28, 2025

(51) Int. Cl. G06T 11/60; G06F 16/54; G06F 40/284; G06F 40/40; G06T 7/73

(52) U.S. Cl. CPC G06T 11/60; G06F 16/54; G06F 40/284; G06F 40/40; G06T 7/73; G06T 2207/20081; G06T 2207/30196

(57) ABSTRACT

The present disclosure relates to systems, non-transitory computer-readable media, and methods for utilizing a multimodal large language model to estimate, hallucinate, and/or repose human poses in digital images. In particular, the disclosed systems receive, from a client device, a digital image and an indication to generate a modified digital image comprising a human. Additionally, the disclosed systems generate, utilizing a multimodal large language model, a text description of predicted pose keypoints based on the digital image. Further, the disclosed systems generate the modified digital image portraying the human utilizing the text description of the predicted pose keypoints. Moreover, the disclosed systems providing, for display, the modified digital image to the client device.

### BACKGROUND

Recent years have seen significant improvements in technology for predicting human poses in images. For example, some conventional systems can determine human body positions for many applications including artificial intelligence (AI) photo-editing, animation, healthcare, augmented reality, etc. However, these systems often struggle to integrate seamlessly with user interfaces while accurately estimating human poses, limiting their effectiveness in dynamic and automated environments for creating and/or modifying images. Without improved integration, the potential of the above-mentioned applications for pose estimation remains constrained. Indeed, conventional systems have a number of drawbacks that negatively impact the flexibility and accuracy of pose estimation systems for application across different use cases.

### SUMMARY

Embodiments of the present disclosure provide benefits and/or solve one or more of the foregoing or other problems in the art with systems, non-transitory computer-readable media, and methods for utilizing a multimodal large language model to estimate, hallucinate, and/or repose human poses in digital images. For example, the disclosed systems integrate with user interfaces by estimating, hallucinating, and/or reposing human poses in digital images based on natural language prompts and/or the digital images. In particular, the disclosed systems train and implement the multimodal large language model to generate predicted pose keypoints. For instance, the disclosed systems utilize the multimodal large language model to estimate a pose of a human in a digital image by generating predicted pose keypoints based on the digital image. In another example, the disclosed systems utilize the multimodal large language model to generate predicted pose keypoints hallucinating a pose for a human to be included in a digital image based on a natural language prompt and/or the digital image. In a further example, the disclosed systems utilize the multimodal large language model to generate predicted pose keypoints for reposing a human in a digital image to a new pose based on a natural language prompt and the digital image including the human.

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a multimodal pose editing system operates in accordance with one or more embodiments.

FIG. 2A illustrates an overview diagram of the multimodal pose editing system utilizing a multimodal large language model to estimate a pose of a human in a digital image in accordance with one or more embodiments.

FIG. 2B illustrates an overview diagram of the multimodal pose editing system utilizing a multimodal large language model to hallucinate a pose of a human in a digital image in accordance with one or more embodiments.

FIG. 2C illustrates an overview diagram of the multimodal pose editing system utilizing a multimodal large language model to repose a human in a digital image in accordance with one or more embodiments.

FIG. 3A illustrates a diagram of the multimodal pose editing system training a multimodal large language model to estimate a pose of a human in a digital image in accordance with one or more embodiments.

FIG. 3B illustrates a diagram of the multimodal pose editing system training a multimodal large language model to hallucinate a human pose corresponding to a digital image in accordance with one or more embodiments.

FIG. 3C illustrates a diagram of the multimodal pose editing system training a multimodal large language model to repose a human in a digital image in accordance with one or more embodiments.

FIG. 4 illustrates a diagram of the multimodal pose editing system estimating a pose of a human in a digital image in accordance with one or more embodiments.

FIG. 5 illustrates a diagram of the multimodal pose editing system utilizing a multimodal large language model to hallucinate a human pose corresponding to a digital image in accordance with one or more embodiments.

FIG. 6 illustrates a diagram of the multimodal pose editing system utilizing a multimodal large language model to repose a human from a first pose to a second pose in accordance with one or more embodiments.

FIG. 7 illustrates a diagram of the multimodal pose editing system providing for display on a client device a keypoint representation and a modified digital image.

FIG. 8 illustrates predicted pose keypoints and retrieved dense pose image performed by the multimodal pose editing system compared with example prior art predicted pose keypoints and retrieved dense pose images in accordance with one or more embodiments.

FIG. 9 illustrates an example schematic diagram of the multimodal pose editing system in accordance with one or more embodiments.

FIG. 10 illustrates a flowchart of an example series of acts for utilizing a multimodal large language model to estimate a human pose, hallucinate a human pose, and/or repose a human corresponding to a digital image in accordance with one or more embodiments.

FIG. 11 illustrates a flowchart of an example series of acts for training a multimodal large language model to estimate a human pose, hallucinate a human pose, and/or repose a human corresponding to a digital image in accordance with one or more embodiments.

FIG. 12 illustrates a block diagram of an example computing device for implementing one or more embodiments of the present disclosure.

### DETAILED DESCRIPTION

This disclosure describes one or more embodiments of a multimodal pose editing system that utilizes a multimodal large language model to estimate, hallucinate, and/or repose human poses in digital images. For example, the multimodal pose editing system integrates with user interfaces by estimating, hallucinating, and/or reposing human poses in digital images based on natural language prompts and/or the digital images. In particular, the multimodal pose editing system trains and implements the multimodal large language model to generate predicted pose keypoints. Further, in some embodiments, the multimodal pose editing system estimates a pose of a human in a digital image by generating predicted pose keypoints based on the digital image. In another example, the multimodal pose editing system generates predicted pose keypoints hallucinating a pose for a human to be included in a digital image based on a natural language prompt and/or the digital image. In a further example, the multimodal pose editing system generates predicted pose keypoints for reposing a human in a digital image to a new pose based on a natural language prompt and the digital image including the human.

As mentioned above, in some implementations, the multimodal pose editing system trains the multimodal large language model to generate a text description of predicted pose keypoints. Specifically, the multimodal pose editing system utilizes ground truth text descriptions of predicted pose keypoints to determine a loss and modifies the parameters of the multimodal large language model based on the loss. For instance, the multimodal pose editing system utilizes ground truth text descriptions of predicted pose keypoints a training dataset that includes humans posing in digital images.

As noted above, in one or more embodiments, the multimodal pose editing system estimates a pose of a human in a digital image by generating a text description of the predicted pose keypoints utilizing a multimodal large language model. In particular, the multimodal pose editing system estimates the pose of the human in the digital image and generates a modified digital image based on the estimated pose. For example, the multimodal pose editing system generates a modified digital image by replacing the human in the digital image with a different human in the same pose based on the estimated pose.

As mentioned previously, in one or more implementations, the multimodal pose editing system generates predicted pose keypoints hallucinating a pose for a human to be included in a digital image based on a natural language prompt and/or the digital image. Specifically, the multimodal pose editing system utilizes the multimodal large language model to generate a text description of predicted pose keypoints. For instance, the multimodal pose editing system hallucinates the text description of the predicted pose keypoints based on a natural language text description (e.g., of a prompt) describing a pose and/or the context of the digital image. To illustrate, the multimodal pose editing system generates the text description of the predicted pose keypoints based on the context of the digital image to include a human in the digital image with a pose that corresponds to the context. In another example, the multimodal pose editing system generates the text description of the predicted pose keypoints based on a natural language prompt text description that describes the pose of the human to be included in a modified version of the digital image.

As noted previously, in some embodiments, the multimodal pose editing system generates predicted pose keypoints for reposing a human in a digital image to a new pose based on a natural language prompt and the digital image including the human. In particular, the multimodal pose editing system utilizes the multimodal large language model to generate a text description of predicted pose keypoints. For example, the multimodal pose editing system generates the text description of predicted pose keypoints based on the digital image and a natural language prompt text description. For instance, the multimodal pose editing system generates the text description of the predicted pose keypoints based on the digital image with the human in a first pose and the prompt text description describing a new second pose.

As previously mentioned, in some implementations, the multimodal pose editing system generates predicted pose keypoints and generates a modified digital image based on the predicted pose keypoints. Specifically, the multimodal pose editing system generates the predicted pose keypoints based on the text descriptions of the predicted pose keypoints.

Moreover, in one or more embodiments, the multimodal pose editing system generates the modified image based on the predicted pose keypoints. For example, the multimodal pose editing system generates (or retrieves from a database) a dense pose image based on the predicted pose keypoints and generates the modified image based on the dense pose image.

Although some conventional systems can estimate the pose of a human in an image, such systems have a number of problems in relation to flexibility of operation and accuracy. For instance, conventional systems demonstrate operational inflexibility by failing to seamlessly integrate with important user interface functionalities. In particular, many conventional systems capable of pose estimation are not multimodal and therefore do not integrate well with natural language prompt interface elements of image editing systems. Indeed, conventional pose estimation systems cannot utilize natural language instructions to modify a digital image by inserting a human with a hallucinated pose or reposing a human in the digital image.

In addition to their operational inflexibilities, conventional systems often do not accurately estimate, hallucinate, and repose human poses while also integrating with image editing system user interfaces. More specifically, conventional multimodal large language model-based systems do not accurately estimate the pose of a human in a digital image, hallucinate new poses for inserting a posed human into a digital image, or repose a human in a digital image, let alone unifying these functions in a single multimodal large language model-based system.

As suggested by the foregoing, embodiments of the multimodal pose editing system provide a variety of improvements relative to conventional systems. For example, by training and implementing a multimodal large language model to estimate, hallucinate, and/or repose a human pose in digital images, the multimodal pose editing system improves flexibility relative to conventional systems. Specifically, the multimodal pose editing system trains a multimodal large language model by generating a text description of predicted pose keypoints of a human utilizing the multimodal large language model, determining a measure of loss for the text description of the predicted pose keypoints, and modifying the parameters of the multimodal large language model based on the measure of loss. Furthermore, in one or more implementations, the multimodal pose editing system implements the trained multimodal large language model by integrating with user interfaces of image editing platforms. Specifically, the multimodal pose editing system utilizes natural language instructions of prompts received via the user interfaces of the image editing platforms to estimate, hallucinate, and/or repose human poses. For example, the multimodal pose editing system generates a text description of predicted keypoints of a human pose, generates predicted pose keypoints and/or a dense pose image based on the text description of the predicted keypoints, and generates a modified image based on the predicted pose keypoints and/or dense pose image.

Additionally, in some embodiments, by training the multimodal large language model to estimate, hallucinate, and/or repose a human pose in digital images, the multimodal pose editing system improves accuracy relative to conventional systems. In particular, the multimodal pose editing system improves the accuracy of estimating, hallucinating, and/or reposing a human pose in a digital image relative to conventional multimodal large language model-based systems. For example, the multimodal pose editing system trains a multimodal large language model as described above. In these or other embodiments, the multimodal pose editing system then implements the trained multimodal large language model to accurately estimate, hallucinate, and repose human poses in digital images as also described above.

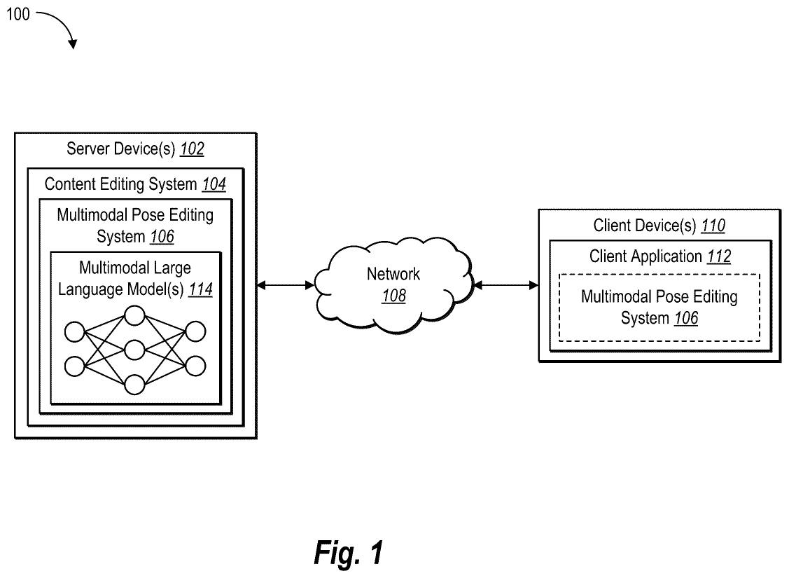

Additional detail regarding the multimodal pose editing system 106 will now be provided with reference to the figures. For example, FIG. 1 illustrates a schematic diagram of a system environment 100 in which a multimodal pose editing system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the multimodal pose editing system 106 via the network 108). Similarly, although FIG. 1 illustrates a particular arrangement of the server device(s) 102, the network 108, and the client device(s) 110, various additional arrangements are possible.

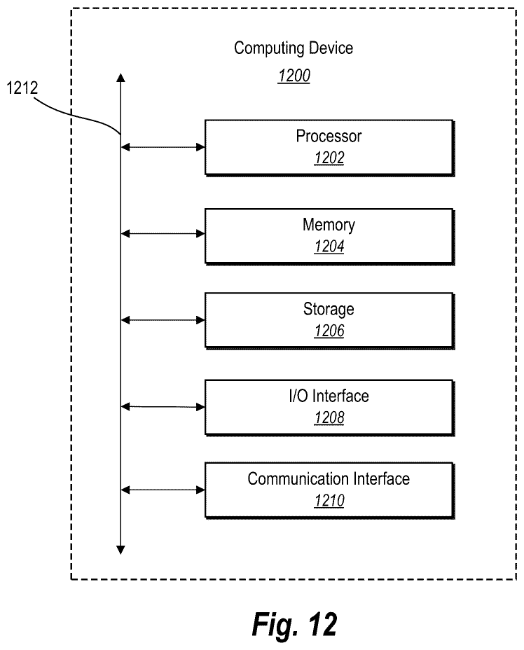

The server device(s) 102, the network 108, and the client device(s) 110 are communicatively coupled with each other either directly or indirectly (e.g., through the network 108 discussed in greater detail below in relation to FIG. 12). Moreover, the server device(s) 102 and the client device(s) 110 include one or more of a variety of computing devices (including one or more computing devices as discussed in greater detail with relation to FIG. 12).

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server, a content editing server, or a web-hosting server.

As shown, the server device(s) 102 includes a content editing system 104. In one or more embodiments, the content editing system 104 provides functionality by which a client device (e.g., the client device(s) 110) views, generates, stores, and/or edits digital content such as digital images. For example, in some instances, a client device sends a digital image to the content editing system 104 hosted on the server device(s) 102 via the network 108. The content editing system 104 then provides options usable by the client device to edit or modify (e.g., by generating a modified digital image) the digital image, store the digital image, and subsequently search for, access, and view the digital documents. To illustrate, the content editing system 104 provides one or more options that are usable by the client device to generate modified digital images based on estimated, hallucinated, or reposed human poses.

As further shown, the server device(s) 102 also include the multimodal pose editing system 106 training multimodal large language models (e.g., the multimodal large language model(s) 114) and/or generating content such as modified digital images therefrom in the content editing system 104. In one or more embodiments, the multimodal pose editing system 106 modifies parameters of a multimodal large language model to enable additional functions. For example, the multimodal pose editing system 106 enables pose estimation, pose hallucination, and/or reposing of human poses. Further, the multimodal pose editing system 106 accesses the multimodal large language model with parameters modified as just described to generate outputs such as modified digital images based on estimated human poses, hallucinated human poses, or new poses reposing a human from a different initial pose.

As illustrated in FIG. 1, the multimodal pose editing system 106 includes a multimodal large language model(s) 114. Indeed, in these or other embodiments, the multimodal pose editing system 106 accesses the multimodal large language model(s) 114 to modify parameters thereof or implements the multimodal large language model(s) 114 to generate outputs such text descriptions of predicted pose keypoints. In some cases, the multimodal large language model(s) 114 are external to the multimodal pose editing system 106, but the multimodal pose editing system 106 nevertheless accesses and utilizes the multimodal large language model(s) 114 via one or more plugins, APIs, or other network-based access protocols.

In some embodiments, a multimodal large language model includes or refers to a specialized type of machine learning model, and more particularly, a specialized type of neural network. For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks, decision trees, support vector machines, linear regression models, and Bayesian networks.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

In one or more implementations, the multimodal large language model(s) 114 includes an artificial intelligence model designed to process and understand both visual inputs and text inputs. Specifically, the multimodal large language model(s) 114 is capable of processing and generating natural language text or other language-based prompts using language understanding as well as processing visual inputs such as digital images. In particular, multimodal large language models are trained on large amounts of data to learn patterns and rules of language and/or images. As such, a large language model post-training is capable of generating output predictions such as predicted text (e.g., left-to-right predicted text). The multimodal pose editing system 106 can utilize a variety of large language model architectures, such as Firefly.

In one or more embodiments, the client device(s) 110 includes a computing device that accesses, edits, segments, modifies, stores, and/or provides, for display, digital content such as digital images and/or modified digital images. For example, in some embodiments, the client device(s) 110 includes a smartphone, a tablet, a desktop computer, a laptop computer, a head-mounted-display device, or another electronic device, including those explained below with reference to FIG. 12. In some instances, the client device(s) 110 includes one or more applications (e.g., a client application 112) that access, edit, segment, modify, store, and/or provide, for display, digital content such as digital images and/or modified digital images. For example, in one or more embodiments, the client application 112 includes a software application installed on the client device(s) 110. Additionally, or alternatively, the client application 112 includes a web browser or other application that accesses a software application hosted on the server device(s) 102 (and supported by the content editing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicates via the network using one or more communication platforms and technologies suitable for transporting data and/or communication signals, including any known communication technologies, devices, media, and protocols supportive of data communications, examples of which are described with reference to FIG. 12.

To provide an example implementation, in some embodiments, the multimodal pose editing system 106 on the server device(s) 102 supports the multimodal pose editing system 106 on the client device(s) 110. For instance, in some cases, the multimodal pose editing system 106 on the server device(s) 102 generates or learns parameters for the multimodal large language model(s) 114. The multimodal pose editing system 106 then, via the server device(s) 102, provides the multimodal large language model(s) 114 to the client device(s) 110. In other words, the client device(s) 110 obtains (e.g., downloads) the multimodal large language model(s) 114 from the server device(s) 102. Once downloaded, the multimodal pose editing system 106 on the client device(s) 110 uses the multimodal large language model(s) 114 to train and or implement the multimodal large language model(s) 114 to generate and implement outputs such as text descriptions of predicted pose keypoints independent of the server device(s) 102. In some implementations, the multimodal pose editing system 106 generates or learns parameters for the multimodal large language model(s) 114 on the client device(s) 110.

In alternative implementations, the multimodal pose editing system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as a training data and/or digital documents for use as input and/or for incorporation with the output of large language model. In response, the multimodal pose editing system 106 on the server device(s) 102 generates modified parameters of a multimodal large language model or text descriptions of predicted pose keypoints using the multimodal large language model with the modified parameters. The server device(s) 102 then provides the text descriptions of the predicted pose keypoints to the client device(s) 110 for display and/or further processing.

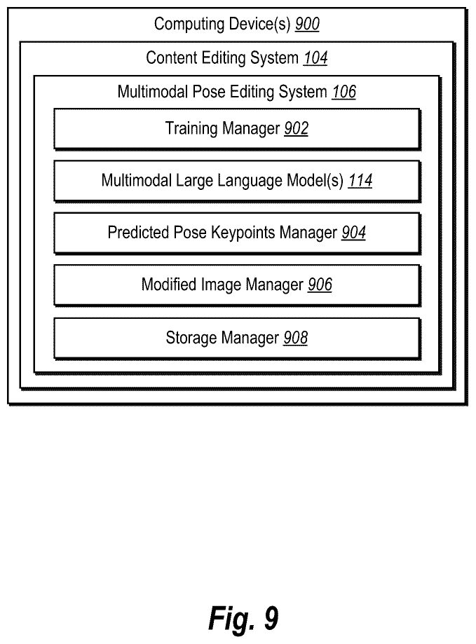

Although FIG. 1 illustrates the multimodal pose editing system 106 implemented with regard to the server device(s) 102, different components of the multimodal pose editing system 106 are able to be implemented by a variety of devices within the system environment 100. For example, in some instances, a different computing device (e.g., the client device(s) 110) or a separate server from the server device(s) 102 implements one or more (or all) components of the multimodal pose editing system 106. Indeed, as shown in FIG. 1, the client device(s) 110 includes the multimodal pose editing system 106. Example components of the multimodal pose editing system 106 will be described below with regard to FIG. 9.

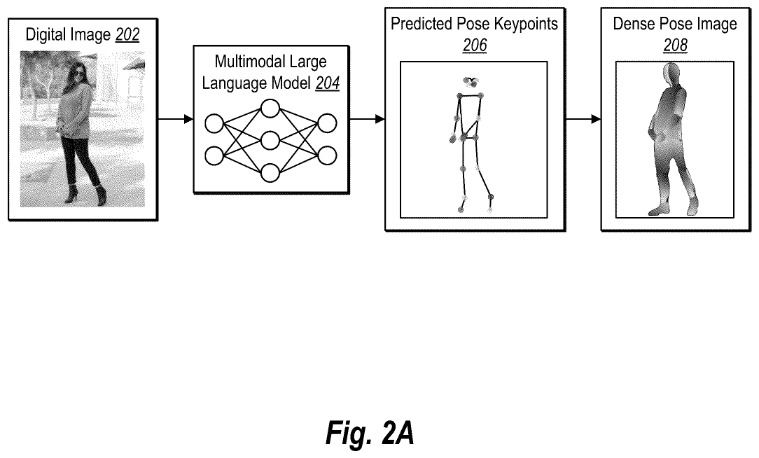

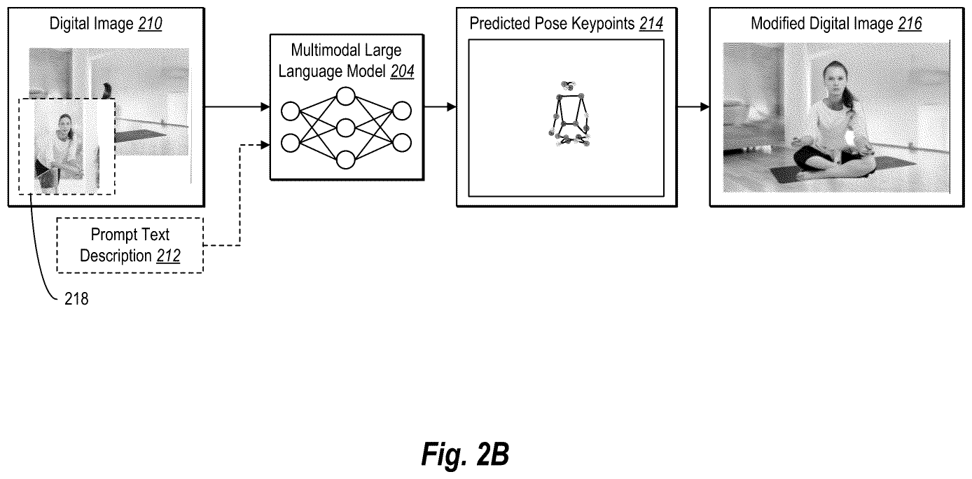

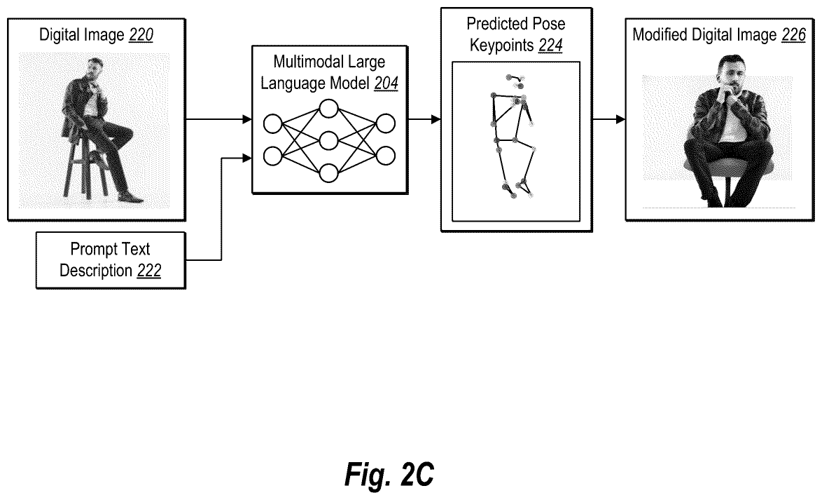

As previously noted, in some implementations, the multimodal pose editing system 106 estimates a human pose, hallucinates a human pose, and/or reposes a human in digital images. For example, the multimodal pose editing system 106 utilizes a multimodal large language model to estimate a human pose, hallucinate a human pose, and/or repose a human in a digital image. FIGS. 2A-2C illustrate overview diagrams of the multimodal pose editing system 106 utilizing a multimodal large language model to estimate a human pose, hallucinate a human pose, and/or repose a human in a digital image in accordance with one or more embodiments. Specifically, FIG. 2A illustrates an overview diagram of the multimodal pose editing system 106 utilizing a multimodal large language model to estimate a pose of a human in a digital image in accordance with one or more embodiments.

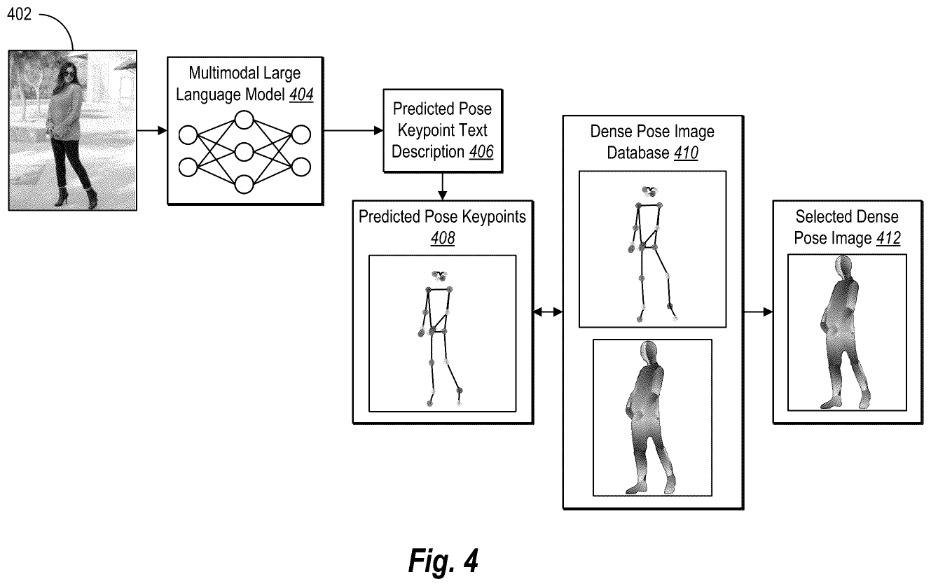

As illustrated in FIG. 2A, in one or more embodiments, the multimodal pose editing system 106 receives a digital image 202 (e.g., from a client device) with an indication (e.g., of a large language model prompt) to estimate a pose of a human in the digital image 202. In particular, the multimodal pose editing system 106 utilizes the digital image 202 with a multimodal large language model 204 (e.g., the multimodal large language model(s) 114 of FIG. 1) to generate predicted pose keypoints 206 representing the pose of the woman standing in the digital image 202. Further, in one or more implementations, the multimodal pose editing system 106 utilizes the predicted pose keypoints 206 to determine a dense pose image 208 estimating the pose of the woman in the digital image 202. In some embodiments, the multimodal pose editing system 106 generates a modified digital image (e.g., by replacing the human in the digital image 202 with a different human) based on the dense pose image 208. Additional detail regarding determining the dense pose image 208 is provided with respect to FIG. 4.

FIG. 2B illustrates an overview diagram of the multimodal pose editing system 106 utilizing a multimodal large language model to hallucinate a pose of a human corresponding to a digital image in accordance with one or more embodiments. As shown in FIG. 2B, in some implementations, the multimodal pose editing system 106 utilizes a digital image 210 and the multimodal large language model 204 to generate a modified digital image 216. Specifically, the multimodal pose editing system 106 hallucinates a pose of woman in the modified digital image 216 based on the context of the digital image 210.

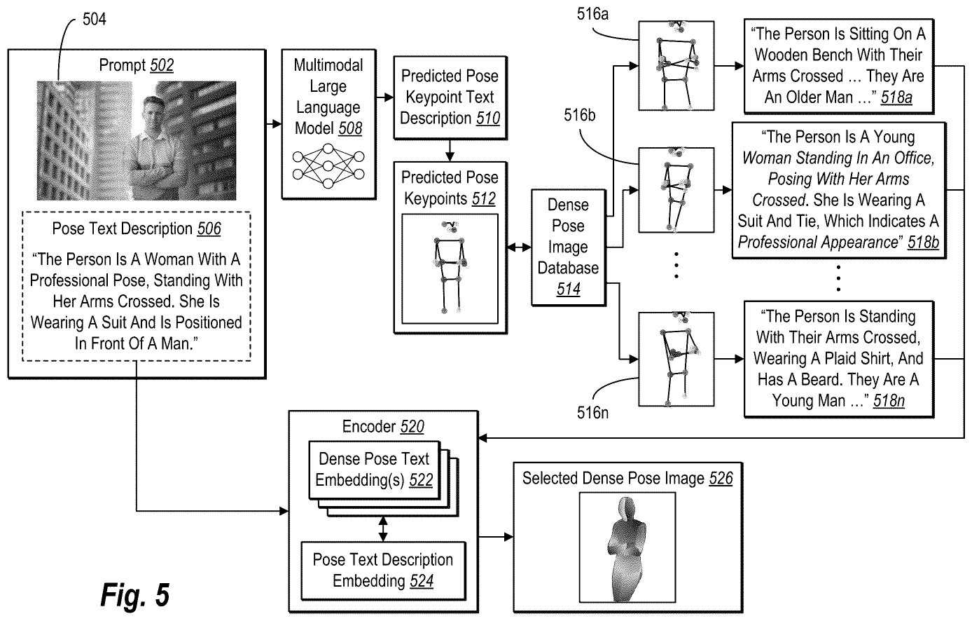

In one or more embodiments, the multimodal pose editing system 106 hallucinates the woman's pose by utilizing a text description of the pose from a large language model prompt (i.e., the prompt text description 212) in addition to the digital image 210. For example, the multimodal pose editing system 106 utilizes the multimodal large language model 204 to hallucinate predicted pose keypoints 214 for generating the modified digital image 216. Moreover, in one or more implementations, the multimodal pose editing system 106 utilizes an additional digital image 218 of the woman for inclusion in the modified digital image 216 according to the predicted pose keypoints 214. Additional detail regarding hallucinating a pose of a human in a digital image is provided with respect to FIG. 5.

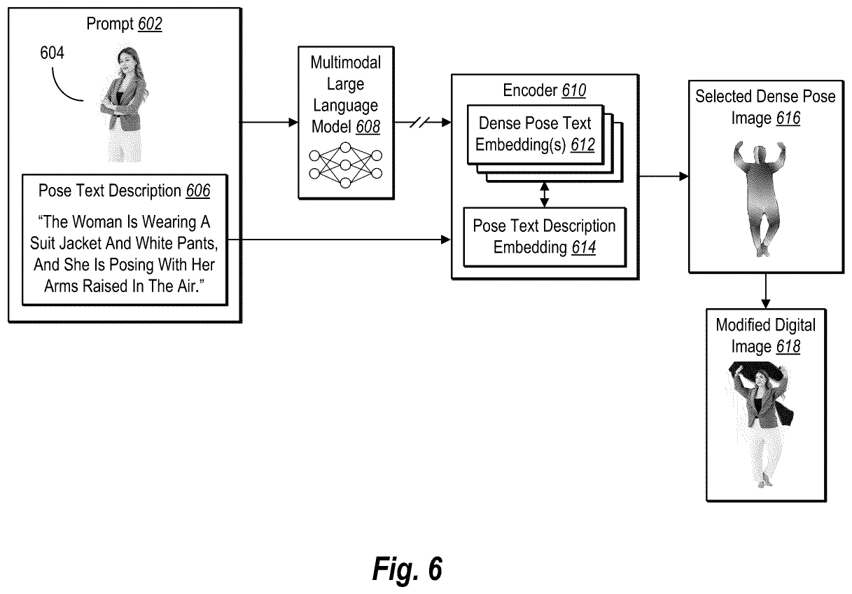

FIG. 2C illustrates an overview diagram of the multimodal pose editing system 106 utilizing a multimodal large language model to repose a human in a digital image in accordance with one or more embodiments. As portrayed in FIG. 2C, in some embodiments, the multimodal pose editing system 106 utilizes a digital image 220 and a prompt text description 222 to generate predicted pose keypoints 224 for reposing a human in the digital image 220. In particular, the multimodal pose editing system 106 utilizes the multimodal large language model 204 with the digital image 220 and the prompt text description 222 to generate the predicted pose keypoints 224. For example, the multimodal pose editing system 106 generates a modified digital image 226 reposing the human from the digital image 220. Additional detail regarding utilizing a multimodal large language model to repose a human in a digital image is provided with respect to FIG. 6.

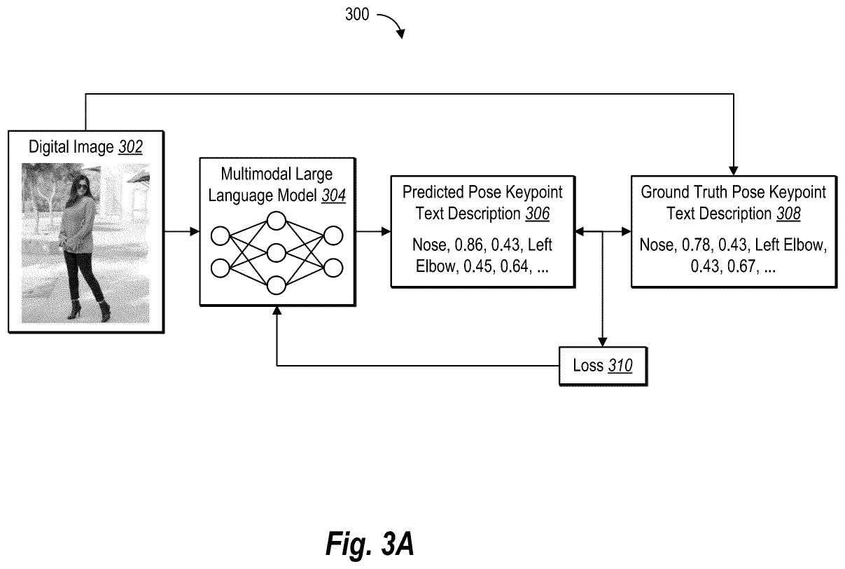

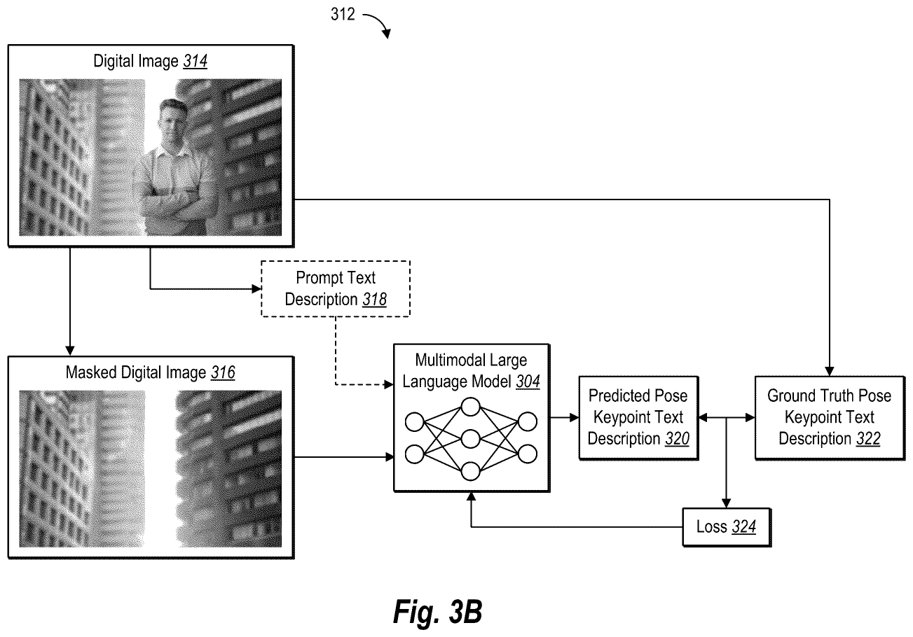

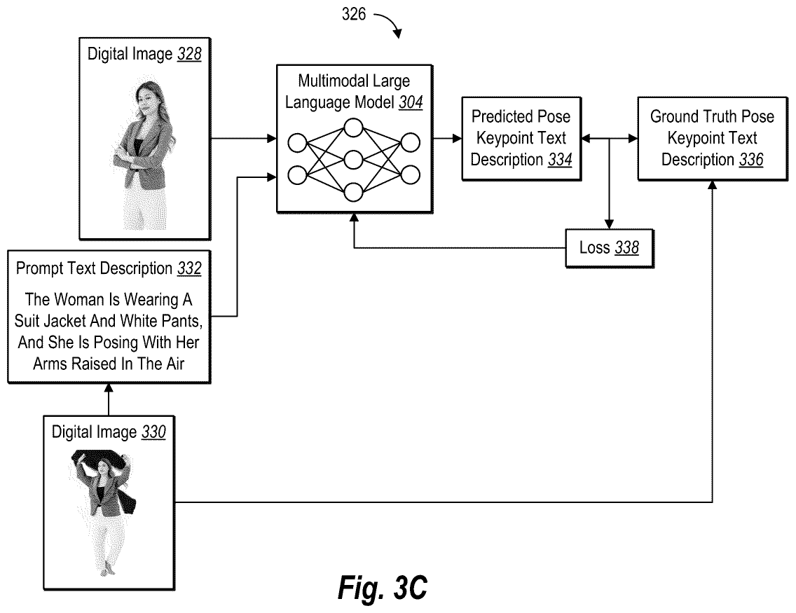

In some implementations, the multimodal pose editing system 106 trains the multimodal large language model 204 to estimate a pose of a human, hallucinate a human pose, and/or repose a human corresponding to a digital image. Additional detail regarding training the model to estimate a human pose, hallucinate a human pose, and/or repose a human, is provided with reference to FIGS. 3A-3C, respectively. Furthermore, in one or more embodiments, the multimodal pose editing system 106 generates a keypoint representation of the pose keypoints for modifying individual keypoint locations for display on a client device. Additional detail regarding generating a keypoint representation of pose keypoints and modifying individual keypoint locations is provided with respect to FIG. 6.

As mentioned above, in one or more implementations, the multimodal pose editing system 106 trains the multimodal large language model 204 to estimate a pose of a human, hallucinate a human pose, and/or repose a human corresponding to a digital image. FIGS. 3A-3C illustrate diagrams of the multimodal pose editing system 106 training a multimodal large language model to estimate a pose of a human, hallucinate a human pose, and/or repose a human corresponding to a digital image in accordance with one or more embodiments. Specifically, FIG. 3A illustrates a diagram of the multimodal pose editing system 106 training a multimodal large language model to estimate a pose of a human in a digital image in accordance with one or more embodiments.

As depicted in FIG. 3A, in some embodiments, the multimodal pose editing system 106 trains a multimodal large language model 304 (e.g., the multimodal large language model 204 of FIG. 2) on a pose prediction training task 300. In particular, the multimodal pose editing system 106 receives a digital image 302. For example, the multimodal pose editing system 106 receives the digital image 302 which is part of a training dataset. In some implementations, the training dataset includes digital images, each of which includes a human and is associated with a set of ground truth pose keypoints, a ground truth text description of the pose keypoints, and a natural language text description of the pose.

In one or more embodiments, a pose keypoint includes a point on a human or other object that represents a landmark for defining a pose (or body position). Specifically, pose keypoints correspond to anatomical locations such as joints (e.g., elbows, knees) or facial features (e.g., eyes, nose). For example, the multimodal pose editing system 106 detects sparse pose keypoints focusing on essential anatomical locations to determine a pose of a human in a digital image.

Additionally, in one or more implementations, a text description of pose keypoints (or pose keypoint text description) includes structured text describing the locations of the pose keypoints. In particular, the pose keypoint text description includes text that utilizes a coordinate system to describe the locations of pose keypoints. For example, the pose keypoint text description includes keypoint names and their corresponding positions, such as on an x, y or x, y, z, coordinate system. In some embodiments, the pose keypoint text description includes a set of keypoint names each followed by the respective x, y coordinates as decimals between 0 and 1. To illustrate, the pose keypoint text description includes the following example, “nose, 0.86, 0.43, left elbow, 0.45, 0.64 . . . ”. In this example, the nose keypoint is located at (0.86, 0.43) in an x, y coordinate system, with 1 representing the upper limit of the x-axis and the far-right position on the y-axis.

As further illustrated in FIG. 3A, in some implementations, the multimodal pose editing system 106 performs the pose prediction training task 300 by training a multimodal large language model 304 (e.g., the multimodal large language model 204) utilizing the training dataset. Specifically, for each digital image (e.g., digital image 302), the multimodal pose editing system 106 generates a large language model prompt including the digital image which includes a human. For instance, the multimodal pose editing system 106 generates the prompt to include the digital image 302 with a woman standing/posing in the front center of the image.

As additionally shown in FIG. 3A, in one or more embodiments, the multimodal pose editing system 106 utilizes the multimodal large language model 304 with the prompt to generate a text description of predicted pose keypoints (i.e., the predicted pose keypoint text description 306) estimating the pose of the woman in the digital image 302. To illustrate, the multimodal pose editing system 106 generates the predicted pose keypoint text description 306 to estimate the pose of the woman as follows, “nose, 0.86, 0.43, left elbow, 0.45, 0.64 . . . ”.

As further illustrated in FIG. 3A, in one or more implementations, the multimodal pose editing system 106 compares the predicted pose keypoint text description 306 with a ground truth pose keypoint text description 308. In some embodiments, the ground truth pose keypoint text description 308 describes ground truth pose keypoints representing the actual pose of the woman in the digital image 302. Indeed, the ground truth pose keypoint text description 308 accurately describes the actual keypoints for the woman's pose in the digital image 302. To illustrate, the ground truth pose keypoint text description 308 describes the actual keypoints as follows, “nose, 0.78, 0.43, left elbow, 0.43, 0.67 . . . ”.

In particular, the multimodal pose editing system 106 determines a loss 310 by comparing the predicted pose keypoint text description 306 with ground truth text tokens of the ground truth pose keypoint text description 308. For example, the multimodal pose editing system 106 determines differences between the x, y coordinates of the keypoints in the predicted pose keypoint text description relative to the ground truth pose keypoint text description 308 and determines the loss 310 (e.g., vi a cross-entropy loss) using these differences. In some implementations, the multimodal pose editing system 106 utilizes a cross-entropy loss function to determine the loss 310. Further, in one or more embodiments, the multimodal pose editing system 106 tokenizes the keypoint text descriptions (e.g., one or more characters per token) prior to determining the loss 310.

As also depicted in FIG. 3A, in one or more implementations, the multimodal pose editing system 106 modifies the parameters of the multimodal large language model 304 based on the measure of loss 310. Specifically, the multimodal pose editing system 106 finetunes the multimodal large language model 304 by employing low rank adapters. Moreover, in some embodiments, the multimodal pose editing system 106 trains the multimodal large language model 304 on a pose hallucination training task (as described further with respect to FIG. 3B) and/or a reposing training task (as described further with respect to FIG. 3C) in addition to the pose prediction training task 300.

In some implementations, for training the multimodal large language model 304 to estimate predicted pose keypoints, the multimodal pose editing system 106 utilizes an estimation dataset of high-quality digital images with a single human in diverse poses with diverse body shapes, age groups, and image backgrounds (e.g., from the LAION-400M dataset). For example, the estimation dataset includes 79,000 images and corresponding dense pose images (e.g., from the LH-400K dataset) as well as 23,000 high-quality images of a single human from stock photos with corresponding dense pose images (e.g., generated from a pretrained dense pose generation model).

FIG. 3B illustrates a diagram of the multimodal pose editing system 106 training a multimodal large language model to hallucinate a human pose corresponding to a digital image in accordance with one or more embodiments. In particular, the multimodal pose editing system 106 trains the multimodal large language model 304 on a pose hallucination training task 312.

As illustrated in FIG. 3B, in one or more embodiments, the multimodal pose editing system 106 receives a digital image 314 for training the multimodal large language model 304. Specifically, the digital image 314 is included in a training dataset (e.g., as described above with respect to FIG. 3A). Furthermore, in one or more implementations, the multimodal pose editing system 106 generates a masked digital image 316. For example, the multimodal pose editing system 106 generates the masked digital image 316 by masking the man posing in the digital image 314 and inpainting the masked area (utilizing a machine learning inpainting model) to fill the masked portion according to the context of the digital image 314.

Additionally, in some embodiments, the multimodal pose editing system 106 generates a text description (e.g., prompt text description 318) which includes a natural language description of a desired human pose. In particular, the multimodal pose editing system 106 generates the prompt text description 318 to include a natural language description of the man posing in the digital image 314. For example, the multimodal pose editing system 106 generates the prompt text description 318 utilizing a pre-trained machine learning model (e.g., a pre-trained large language model) to caption the digital image 314.

Additionally, in some implementations, the multimodal pose editing system 106 generates a large language model prompt to include the prompt text description 318 and/or the masked digital image 316. In these or other embodiments, the multimodal pose editing system 106 utilizes the generated prompt with the multimodal large language model 304 to generate a predicted pose keypoint text description 320. Specifically, the multimodal pose editing system 106 generates the predicted pose keypoint text description 320 to hallucinate the pose of a human based on the context of the masked digital image 316.

To illustrate, if the large language model prompt does not include the prompt text description 318, the multimodal pose editing system 106 generates the predicted pose keypoint text description 320 based on the context of the masked digital image 316. In particular, the multimodal pose editing system 106 utilizes the multimodal large language model 304 to determine the predicted pose keypoint text description 320 based on the content remaining in the masked digital image 316 (e.g., background content, foreground content, etc.). In this example, the multimodal pose editing system 106 determines the predicted pose keypoint text description 320 based on the buildings remaining in the masked digital image 316 (e.g., after inpainting).

To further illustrate, if the large language model prompt does include the prompt text description 318, the multimodal pose editing system 106 determines the predicted pose keypoint text description 320 based on the prompt text description 318 and the context of the masked digital image 316. Specifically, the multimodal pose editing system 106 utilizes the multimodal large language model 304 to generate the predicted pose keypoint text description 320 based on the natural language description of the desired human pose of the prompt text description 318 (and the masked digital image 316).

As further illustrated in FIG. 3B, in one or more embodiments, the multimodal pose editing system 106 generates a ground truth pose keypoint text description 322. In particular, the multimodal pose editing system 106 generates the ground truth pose keypoint text description 322 based on the digital image 314. For example, the multimodal pose editing system 106 utilizes a pre-trained machine learning model to generate ground truth keypoints representing the man's pose in the digital image 314 and generates the ground truth pose keypoint text description 322 based on the ground truth keypoints. In these or other embodiments, the ground truth pose keypoint text description 322 represents the actual pose of the man in the digital image 314.

As additionally shown in FIG. 3B, in one or more implementations, the multimodal pose editing system 106 determines a measure of loss (e.g., loss 324) for the predicted pose keypoint text description 320 hallucinating the pose of a human. Specifically, the multimodal pose editing system 106 determines the loss 324 by comparing tokens of the predicted pose keypoint text description 320 with ground truth tokens of a ground truth pose keypoint text description 322 as described above with respect to FIG. 3A.

As further illustrated in FIG. 3B, in some embodiments, the multimodal pose editing system 106 modifies the parameters of the multimodal large language model 304 based on the loss 324. In particular, the multimodal pose editing system 106 modifies the parameters of the multimodal large language model 304 based on the loss 324 utilizing similar methods as described above with respect to FIG. 3A. Further, in some implementations, the multimodal pose editing system 106 trains the multimodal large language model 304 on a reposing training task (as described further with respect to FIG. 3C) in addition to the pose hallucination training task 312.

In one or more embodiments, the multimodal pose editing system 106 utilizes a hallucination dataset of high-quality images of humans in diverse poses and scenes from a large body of stock photos for training the multimodal large language model 304 to hallucinate predicted pose keypoints. For instance, the multimodal pose editing system 106 utilizes the images after the human in the image has been removed. Further, the hallucination dataset includes dense pose images of the person in the image prior to removal (e.g., generated from a pretrained dense pose generation model). Moreover, in one or more implementations, the hallucination dataset includes text descriptions of the poses of the humans (e.g., generated using a pretrained captioning model).

FIG. 3C illustrates a diagram of the multimodal pose editing system 106 training a multimodal large language model to repose a human in a digital image in accordance with one or more embodiments. Specifically, the multimodal pose editing system 106 trains the multimodal large language model 304 on a reposing training task 326.

As shown in FIG. 3C, in some embodiments, the multimodal pose editing system 106 receives a digital image 328 including a woman in a first pose with her arms folded in the center of the digital image 328. In particular, the digital image 328 is part of a training dataset (e.g., as described in part above with respect to FIG. 3A). Furthermore, in some implementations, the multimodal pose editing system 106 receives a second digital image 330 (of the training dataset) including the same woman in a second pose differing from the first pose of the woman in the digital image 328.

As also depicted in FIG. 3C, in one or more embodiments, the multimodal pose editing system 106 generates a prompt text description 332 based on the second digital image 330. Specifically, the multimodal pose editing system 106 generates the prompt text description 332 to include a natural language description of the woman's pose in the second digital image 330. For example, the multimodal pose editing system 106 generates the prompt text description 332 utilizing a pre-trained machine learning model to caption the second digital image 330. To illustrate, the prompt text description 332 includes a natural language description as follows, “the woman is wearing a suit jacket and white pants, and she is posing with her arms raised in the air.”

In one or more implementations, the multimodal pose editing system 106 generates a large language model prompt. In particular, the multimodal pose editing system 106 generates the large language model prompt to include the digital image 328 of the woman in the first pose and the prompt text description 332 describing the second pose of the woman in the second digital image 330.

As further illustrated in FIG. 3C, in some embodiments, the multimodal pose editing system 106 utilizes the large language model prompt with the multimodal large language model 304 to generate a predicted pose keypoint text description 334. Specifically, the multimodal pose editing system 106 generates the predicted pose keypoint text description 334 to repose the human from the first pose to the second pose. For example, the multimodal pose editing system 106 generates the predicted pose keypoint text description 334 to describe pose keypoints of the second pose of the woman in the second digital image 330. Indeed, in these or other embodiments, the multimodal pose editing system 106 generates the predicted pose keypoint text description 334 to describe the prompt text description 332.

As additionally shown in FIG. 3C, in some implementations, the multimodal pose editing system 106 generates a ground truth pose keypoint text description 336. In particular, the multimodal pose editing system 106 generates the ground truth pose keypoint text description 336 based on the second digital image 330. For example, the multimodal pose editing system 106 utilizes a pre-trained machine learning model to generate ground truth keypoints representing the woman's second pose in the second digital image 330 and generates the ground truth pose keypoint text description 336 based on the ground truth keypoints. In these or other embodiments, the ground truth pose keypoint text description 336 represents the actual pose of the woman in the second digital image 330.

As further illustrated in FIG. 3C, in one or more embodiments, the multimodal pose editing system 106 determines a measure of loss (e.g., loss 338) for the predicted pose keypoint text description 334 reposing the woman to a second pose. Specifically, the multimodal pose editing system 106 determines the loss 338 by comparing tokens of the predicted pose keypoint text description 334 with ground truth tokens of a ground truth pose keypoint text description 336.

As also depicted in FIG. 3C, in one or more implementations, the multimodal pose editing system 106 modifies the parameters of the multimodal large language model 304 based on the loss 338. In particular, the multimodal pose editing system 106 modifies the parameters of the multimodal large language model 304 utilizing similar methods as described above with respect to FIG. 3A. In some embodiments, for training the multimodal large language model 304 to generate predicted pose keypoints reposing the human, the multimodal pose editing system 106 utilizes a reposing dataset of stock image pairs of the same person in different poses.

In some implementations, the multimodal pose editing system 106 trains the machine learning model 304 to generate the predicted pose keypoint text descriptions to include text corresponding to sparse pose keypoints. In particular, the multimodal pose editing system 106 detects 33 human pose landmarks, such as ‘nose,’ ‘left elbow,’ ‘right thumb,’ etc. Further, in some embodiments, the multimodal pose editing system 106 fine-tunes the multimodal large language model 304 to output the predicted pose keypoint text descriptions in a specified format.

In some embodiments, the multimodal pose editing system 106 utilizes each keypoint's name and position relative to the image size, and fine-tunes the multimodal large language model 304 to generate the text of the predicted pose keypoint text description in the following format:

[k₁,x₁,y₁, . . . ,kᵢ,xᵢ,yᵢ, . . . ,kₙ,xₙ,yₙ].

In this format, kᵢ is the keypoint's name, xi is the x-coordinate of the keypoint, and yᵢ is the y-coordinate for each of the keypoints (e.g., n=33). At inference time, the multimodal pose editing system 106 post processes the string of keypoints predicted by the multimodal large language model 304 into a 33×2 array consisting of x- and y-coordinates represented as a decimal between 0 and 1. Moreover, in some implementations, the multimodal pose editing system 106 denotes any pose keypoints that are not visible in the image (which are converted to a negative integer during post-processing) as ‘None’.

In some implementations, the multimodal pose editing system 106 fine-tunes the multimodal large language model 304 using low-rank adapters and employs cross-entropy loss on the text tokens of the predicted pose keypoint text descriptions. Furthermore, in one or more embodiments, the multimodal pose editing system 106 curates a dataset for each of the tasks: human pose estimation, pose hallucination, and reposing. in one or more implementations, all images of the dataset are padded to a square with white pixels. Additionally, in some embodiments, the multimodal pose editing system 106 aggregates all of the data into a single dataset. In some implementations, the multimodal pose editing system 106 finetunes a large language model with a vision encoder (e.g., Large Language and Vision Assistant or LLaVA) to perform all three tasks using a percentage (e.g., 95%) of the combined dataset, and evaluates on the remaining percentage (e.g., 5%) of the data.

As noted above, in some implementations, the multimodal pose editing system 106 utilizes a trained multimodal large language model to estimate a pose of a human in a digital image. Indeed, in one or more embodiments, the multimodal pose editing system 106 utilizes the estimated pose of the digital image to determine a dense pose image for generating a modified digital image. FIG. 4 illustrates a diagram of the multimodal pose editing system 106 estimating a pose of a human in a digital image in accordance with one or more embodiments.

As portrayed in FIG. 4, in one or more implementations, the multimodal pose editing system 106 receives a digital image 402 (e.g., from a client device). Specifically, the multimodal pose editing system 106 receives the digital image 402 which includes a woman posing in the center of the digital image 402. Additionally, in some embodiments, the multimodal pose editing system 106 receives an indication to generate a modified digital image based on the digital image 402. For instance, the multimodal pose editing system 106 receives a prompt (e.g., a large language model prompt from a client device) including instructions to modify the digital image 402 (e.g., by replacing the woman with a different human in the same pose)

As further illustrated in FIG. 4, in some implementations, the multimodal pose editing system 106 utilizes a multimodal large language model 404 (e.g., the multimodal large language model 204 of FIG. 2) to generate pose keypoints for the woman's pose in the digital image 402. In particular, the multimodal pose editing system 106 utilizes the multimodal large language model 404 to generate a predicted pose keypoint text description 406 estimating the woman's pose in the digital image 402. For example, the multimodal pose editing system 106 generates the predicted pose keypoint text description 406 to describe pose keypoints of the woman in a text format.

To illustrate, the multimodal pose editing system 106 generates the predicted pose keypoint text description 406 to describe in an alphanumerical text description the position of the woman's features in the digital image 402. In these or other embodiments, the multimodal pose editing system 106 generates the predicted pose keypoint text description 406 describing individual features of the woman (e.g., “nose, 0.86, 0.43, left elbow, 0.45, 0.64, . . . ”).

As additionally shown in FIG. 4, in one or more embodiments, the multimodal pose editing system 106 generates predicted pose keypoints 408 based on the predicted pose keypoint text description 406. Specifically, the multimodal pose editing system 106 generates the predicted pose keypoints 408 for the woman's pose in the digital image 402. To illustrate, the multimodal pose editing system 106 generates a keypoint representation of the described keypoints. For instance, the multimodal pose editing system 106 parses the predicted pose keypoint text description 406 into an array. In one or more implementations, based on this array, the multimodal pose editing system 106 generates the keypoint representation in two-dimensions with the pose keypoints connected by edges as illustrated in FIG. 4.

As further illustrated in FIG. 4, in some embodiments, the multimodal pose editing system 106 the multimodal pose editing system 106 selects a dense pose image by comparing the predicted pose keypoints 408 with pose keypoints in a dense pose image database 410. In particular, the dense pose image database 410 includes dense pose image/pose keypoint pairs. For example, the dense pose image database 410 includes dense pose images corresponding to pose keypoints (or keypoint representations of the pose keypoints) of human poses extracted from digital images including a human. Further, in some implementations, the dense pose image database 410 includes a caption (e.g., text description) describing the pose of the human in the digital image for each dense pose image/pose keypoint pair.

As mentioned previously, in one or more embodiments, the multimodal pose editing system 106 compares the predicted pose keypoints 408 for the woman in the digital image 402 to the pose keypoints representing human poses in the dense pose image database 410 to select a dense pose image. Specifically, the multimodal pose editing system 106 utilizing a similarity comparison. To illustrate, the multimodal pose editing system 106 utilizes a nearest neighbor's search. For example, the multimodal pose editing system 106 determines the Euclidean distance between each of the individual pose keypoints for a particular pose in the dense pose image database 410 and the individual keypoints of the predicted pose keypoints 408 of the woman in the digital image 402. In these or other embodiments, based on the similarity comparison, the multimodal pose editing system 106 determines the pose most similar to that of the woman in the digital image 402 and selects the corresponding dense pose image as the selected dense pose image 412.

In one or more implementations, the multimodal pose editing system 106 generates a modified digital image based on the selected dense pose image 412. In particular, the multimodal pose editing system 106 generates the modified digital image based on the instructions of the prompt received via the client device. To illustrate, if the prompt includes instructions to modify the digital image 402 by replacing the woman with another person, the multimodal pose editing system 106 utilizes the selected dense pose image 412 to generate the modified digital image with another person in the same pose as the woman. Moreover, the multimodal pose editing system 106 provides the modified digital image for display to the client device.

In one or more embodiments, the multimodal pose editing system 106 generates the modified digital image utilizing a generative machine learning model. In particular, the multimodal pose editing system 106 utilizes the selected dense pose image 412 with the generative machine learning model to generate the modified digital image. For example, the generative machine learning model utilizes the detailed information of the selected dense pose image 412 to generate a realistic image of a person that matches the estimated pose. In some embodiments, the generative machine learning model includes a generative adversarial network (GAN), a diffusion neural network, a pose2image model, or a pose guided person image generation model.

In some implementations, the multimodal pose editing system 106 utilizes the multimodal large language model 404 to generate the keypoints (e.g., the predicted pose keypoint text description 406 and/or the predicted pose keypoints 408) based on a photo containing a single human (e.g., the digital image 402). In these or other embodiments, the multimodal pose editing system 106 prompts the multimodal large language model 404 with a task description and the desired output, such as with the following prompt:
“USER: <image> Pose estimation. Generate the keypoints of this person's pose.
Use the format [keypoint_1, x_1, y_1, keypoint_2, x_2, y_2].”

As noted previously, in some embodiments, the multimodal pose editing system 106 utilizes a trained multimodal large language model to hallucinate a human pose corresponding to a digital image. Indeed, in some implementations, the multimodal pose editing system 106 hallucinates a human pose for determining a dense pose image to generate a modified digital image including a human according to the hallucinated pose. FIG. 5 illustrates a diagram of the multimodal pose editing system 106 utilizing a multimodal large language model to hallucinate a human pose corresponding to a digital image in accordance with one or more embodiments.

As depicted in FIG. 5, in one or more embodiments, the multimodal pose editing system 106 receives a prompt 502 including a digital image 504. In this example, the digital image 504 includes a man crossing his arms. In other examples, the digital image 504 does not include a human. Furthermore, in one or more implementations, the prompt 502 includes an indication to generate a modified digital image (e.g., by inserting a human into the modified digital image). In some embodiments, the prompt 502 includes a text description of a human pose (e.g., a pose text description 506) for including a human (or an additional human) into the digital image 504. To illustrate, the pose text description 506 includes the following text description for including a woman in the digital image 504, “the person is a woman with a professional pose, standing with her arms crossed. She is wearing a suit and is positioned in front of a man.”

As also depicted in FIG. 5, in some implementations, the multimodal pose editing system 106 utilizes the prompt 502 and a multimodal large language model 508 (e.g., the multimodal large language model 204 of FIG. 2) to generate a predicted pose keypoint text description 510. Specifically, the multimodal pose editing system 106 generates the predicted pose keypoint text description 510 to hallucinate a pose of a human to be inserted into the modified digital image. For instance, the multimodal pose editing system 106 generates the predicted pose keypoint text description 510 to hallucinate a human pose based on the context of the digital image 504.

In one or more embodiments, the multimodal pose editing system 106 generates the predicted pose keypoint text description 510 based on the pose text description 506. In particular, the multimodal pose editing system 106 generates the predicted pose keypoint text description 510 to hallucinate a pose of a woman to be inserted into the modified digital image based on the pose text description 506 and the digital image 504. To illustrate, the multimodal pose editing system 106 generates the predicted pose keypoint text description 510 to describe the position of the woman's features in an alphanumerical description (e.g., “nose, 0.68, 0.48, left elbow, 0.45, 0.57, . . . ”).

As further illustrated in FIG. 5, in one or more implementations, the multimodal pose editing system 106 generates predicted pose keypoints 512 based on the predicted pose keypoint text description 510. Specifically, the multimodal pose editing system 106 generates the predicted pose keypoints 512 for the pose of the woman to be added to the digital image 504 utilizing similar methods as described above with respect to FIG. 4.

As additionally shown in FIG. 5, in some embodiments, the multimodal pose editing system 106 selects a dense pose image 526 by comparing the predicted pose keypoints 512 with pose keypoints in a dense pose image database 514 (e.g., the dense pose image database 410 of FIG. 4). In particular, in embodiments wherein the prompt 502 includes the digital image 504 but not the pose text description 506, the multimodal pose editing system 106 determines the selected dense pose image 526 utilizing similar methods to those described above with respect to FIG. 4. For example, the multimodal pose editing system 106 utilizes a similarity comparison to determine the selected dense pose image 526 from the dense pose image database 514.

To illustrate, the multimodal pose editing system 106 utilizes the multimodal large language model 508 to generate the predicted pose keypoint text description 510 based on the context of the digital image 504. Additionally, the multimodal pose editing system 106 generates and compares the predicted pose keypoints 512 to pose keypoints in the dense pose image database 514 utilizing a similarity comparison. Based on the similarity comparison, the multimodal pose editing system 106 determines the pose most similar to the predicted pose keypoints 512 and selects the corresponding dense pose image.

As further illustrated in FIG. 5, in some implementations, the multimodal pose editing system 106 the multimodal pose editing system 106 selects the dense pose image 526 based on the predicted pose keypoints 512. Specifically, the multimodal pose editing system 106 selects a subset of dense pose images in the dense pose image database 514 based on the predicted pose keypoints 512. For example, the multimodal pose editing system 106 selects the subset of dense pose images in the dense pose image database 514 by determining a subset of pose keypoints 516a, 516b, . . . , and 516n (or 516a-n) representing poses most similar to the predicted pose keypoints 512. In these or other embodiments, the multimodal pose editing system 106 determines the subset of pose keypoints 516a-n based on a similarity comparison as described above. In this example, however, rather than determining a single pose most similar to the predicted pose keypoints 512, the multimodal pose editing system 106 determines a threshold number of poses as the subset of pose keypoints 516a-n.

Further, in one or more embodiments, the multimodal pose editing system 106 the multimodal pose editing system 106 selects the selected dense pose image 526 from the subset of dense pose images. In particular, the multimodal pose editing system 106 selects the selected dense pose image 526 from the subset of dense pose images based on captions 518a, 518b, . . . , and 518n (or 516a-n) corresponding to the subset of pose keypoints 516a-n and subset of dense pose images. As previously mentioned, the dense pose image database includes a caption (e.g., text description) describing the pose of the human in the digital image for each dense pose image/pose keypoint pair. For example, the multimodal pose editing system 106 selects the captions 518a-n that correspond to the subset of pose keypoints 516a-n.

Moreover, in one or more implementations, the multimodal pose editing system 106 generates dense pose text embeddings 522 based on the selected captions 518a-n. Specifically, the multimodal pose editing system 106 utilizes an encoder 520 to generate the dense pose text embeddings 522. In some embodiments, the encoder 520 includes a neural network designed to process and extract meaningful representations from text by converting the text into a structured, lower-dimensional feature space. Specifically, an encoder utilizes convolutional or transformer-based architectures to learn hierarchical patterns, spatial relationships, and/or semantic information for use in downstream tasks such as performing comparisons between text embeddings. For example, the multimodal pose editing system 106 generates a dense pose text embedding 522 for each of the selected captions 518a-n.

As also depicted in FIG. 5, in some implementations, the multimodal pose editing system 106 the multimodal pose editing system 106 selects the dense pose image 526 based the pose text description 506. In particular, the multimodal pose editing system 106 generates a text embedding (e.g., pose text description embedding 524) of the pose text description 506 for comparison with the dense pose text embeddings 522. In one or more embodiments, the multimodal pose editing system 106 utilizes a similarity comparison (e.g., by computing a cosine similarity on the embeddings) to select the caption with maximum similarity to the pose text description 506. Furthermore, in one or more implementations, the multimodal pose editing system 106 selects the dense pose image corresponding to the selected caption.

To illustrate, the multimodal pose editing system 106 compares the dense pose text embeddings 522 to the pose text description embedding 524 and determines that the caption 518b has the maximum similarity to the pose text description 506 (e.g., closest in feature space, highest cosine similarity, etc.). Indeed, the caption 518b includes the following text description “the person is a young woman standing in an office posing with her arms crossed. She is wearing a suit and tie, which indicates a professional appearance” which is most similar to the pose text description 506. Additionally, the multimodal pose editing system 106 selects the selected dense pose image 526 which corresponds to the caption 518b.

In some embodiments, the multimodal pose editing system 106 selects the selected dense pose image 526 utilizing other methods. For example, in some implementations, the multimodal pose editing system 106 determines a similarity (e.g., a Euclidean distance) for the pose keypoints of poses in the dense pose image database 410 and the predicted pose keypoints 408. Further, the multimodal pose editing system 106 determines a similarity (e.g., a cosine similarity) for dense pose text embeddings of the captions in the dense pose image database 410 with the pose text description embedding 524. In these or other embodiments, the multimodal pose editing system 106 sums the two similarities (e.g., the Euclidean distance and the cosine similarity) to select the selected dense pose image 526.

Moreover, in one or more embodiments, the multimodal pose editing system 106 generates a modified digital image based on the selected dense pose image 526. For example, the multimodal pose editing system 106 generates the modified digital image by inserting a woman into the modified digital image based on the dense pose (e.g., in front of the man with his arms crossed according to the selected dense pose image 526 and/or by cropping out the man, infilling the image without the man, and then placing the woman into the modified digital image according to the dense pose). In one or more implementations, the multimodal pose editing system 106 also receives (e.g., via a client device) a reference image for inclusion into the prompt 502. Specifically, the reference image includes a reference human for insertion into the modified digital image. In these or other embodiments, the multimodal pose editing system 106 inserts the reference human into the modified digital image according to the hallucinated pose (i.e., according to the selected dense pose image 526). Furthermore, the multimodal pose editing system 106 provides the modified digital image for display to the client device. In one or more embodiments, the multimodal pose editing system 106 utilizes the selected dense pose image 526 with a generative machine learning model to generate the modified digital image as described above with respect to FIG. 4.

In some embodiments, the multimodal pose editing system 106 utilizes the multimodal large language model 508 to predict what is present in the digital image (e.g., the digital image 504) and/or reason further about what could exist in the digital image (e.g., how a human might pose in a scene of the digital image). Specifically, the multimodal pose editing system 106 enables the machine learning model 508 to hallucinate based on a desired pose following a text description, and the digital image 504 includes a scene without the person whose pose is described (e.g., in the prompt 502). In one or more embodiments, the multimodal pose editing system 106 obtains pose descriptions of digital images containing humans by using a pre-trained multimodal large language model to perform image captioning. For example, the multimodal pose editing system 106 utilizes a prompt including instructions for hallucinating a pose, such as the following prompt:
“USER: <image> Pose hallucination. Generate the keypoints of a person's pose following this description. {pose description} Use the format [keypoint_1, x_1, y_1, keypoint_2, x_2, y_2].”

In some implementations such as where a user does not know what kind of pose to generate, the multimodal pose editing system 106 utilizes the multimodal large language model 508 to hallucinate a compatible pose for a scene without receiving a pose text description 506. In one or more implementations, the multimodal pose editing system 106 does not use a pose text description for a certain percentage (e.g., 38%) of the time when training the multimodal large language model on the pose hallucination dataset. In these or other embodiments, the multimodal pose editing system 106 utilizes a prompt including instructions for hallucinating a pose, such as the following prompt:
“USER: <image> Pose hallucination. Generate the keypoints of how a person could pose in this scene. Use the format [keypoint_1, x_1, y_1, keypoint_2, x_2, y_2].”

As previously noted, in some embodiments, the multimodal pose editing system 106 utilizes a trained multimodal large language model to repose a human in a digital image. Indeed, in some implementations, the multimodal pose editing system 106 generates a second pose different from a first pose of a human in a digital image and determines a dense pose image based on the second pose to generate a modified digital image. FIG. 6 illustrates a diagram of the multimodal pose editing system 106 utilizing a multimodal large language model to repose a human from a first pose to a second pose in accordance with one or more embodiments.

As illustrated in FIG. 6, in one or more embodiments, the multimodal pose editing system 106 receives (e.g., from a client device) a prompt 502 including a digital image 604. In this example, the digital image 604 includes a woman posing with her arms crossed. Additionally, in one or more implementations, the prompt 602 includes an indication to generate a modified digital image reposing the woman in the digital image 604. For instance, the multimodal pose editing system 106 receives a text description (e.g., a pose text description 606) including a second pose differing from the first pose of the woman in the digital image 604. To illustrate, the multimodal pose editing system 106 receives the pose text description 606 including the following description, “the woman is wearing a suit jacket and white pants, and she is posing with her arms raised in the air.”

As further illustrated in FIG. 6, in some embodiments, the multimodal pose editing system 106 utilizes the prompt 602 with a multimodal large language model 608 (e.g., the multimodal large language model 204 of FIG. 2) to generate a text description of predicted pose keypoints for reposing the woman in the digital image 604 according to the second pose. For example, the multimodal pose editing system 106 generates the text description of the predicted pose keypoints utilizing similar methods to those described above with respect to FIGS. 4 and 5.

As additionally shown in FIG. 6, in some implementations, the multimodal pose editing system 106 determines a dense pose image (e.g., selected dense pose image 616) from a dense pose image database (e.g., the dense pose image database 514) utilizing similar methods to those described above with respect to FIG. 5. For example, the multimodal pose editing system 106 selects a subset of dense pose images from the dense pose image database based on a corresponding subset of pose keypoints of poses in the dense pose image database. In these or other embodiments, the multimodal pose editing system 106 further utilizes an encoder 610 (e.g., the encoder 520 of FIG. 5) to generate dense pose text embeddings 612 utilizing similar methods to those described above with respect to FIG. 5.

As further illustrated in FIG. 6, in one or more embodiments, the multimodal pose editing system 106 determines the selected dense pose image 616 based on the pose text description 606 for reposing the woman in the digital image 604. In particular, the multimodal pose editing system 106 generates a pose text description embedding 614 for comparison with the dense pose text embeddings 612 utilizing methods similar to those described with respect to FIG. 5. Further, in one or more implementations, the multimodal pose editing system 106 selects the selected dense pose image 616 utilizing similar methods to those described above with respect FIG. 5.

As also depicted in FIG. 6, in some embodiments, the multimodal pose editing system 106 generates a modified digital image 618 based on the selected dense pose image 616. Specifically, the multimodal pose editing system 106 generates the modified digital image 618 by reposing the woman from the digital image 604 according to the second pose as embodied in the selected dense pose image 616. Indeed, as illustrated, the multimodal pose editing system 106 generates the modified digital image 618 with the same woman from the digital image 604 in the new (second) pose with her arms raised in the air. In some implementations, the multimodal pose editing system 106 utilizes the selected dense pose image 616 with a generative machine learning model to generate the modified digital image 618 as described above with respect to FIG. 4. Moreover, the multimodal pose editing system 106 provides the modified digital image 618 for display to the client device.

In some embodiments, the multimodal pose editing system 106 utilizes the machine learning model 608 to imagine how someone could change an existing pose in the scene of a digital image (e.g., the digital image 604). In one or more embodiments, this includes utilizing a text description of the new pose as well as information on the person's body shape, which the multimodal pose editing system 106 generates from a pretrained multimodal large language model. In these or other embodiments, the input digital image (e.g., digital image 604) utilizes the machine learning model 608 to generate a new pose for the person. For example, the multimodal pose editing system 106 utilizes a prompt (e.g., the prompt 602) including instructions for the reposing task such as the following prompt:

“USER: <image> Reposing. Generate the keypoints of a new pose for this person following this description. {pose description} Use the format [keypoint_1, x_1, y_1, keypoint_2, x_2, y_2].”

In some implementations, the multimodal pose editing system 106 generates modified digital images from the pose keypoints. In particular, the multimodal pose editing system 106 generates the modified digital images directly from the pose keypoints without generating or retrieving a dense pose image. In these or other embodiments, the multimodal pose editing system 106 generates the modified digital images based on the pose keypoints for any one of (i) estimating a pose of a human in a digital image, (ii) hallucinating a pose of a human not included in a digital image, or (iii) reposing a human in a digital image.

In one or more embodiments, the multimodal pose editing system 106 generates a dense pose image utilizing a decoder machine learning model. Specifically, the multimodal pose editing system 106 utilizes the decoder machine learning model trained to generate dense pose images based on pose keypoints. For example, the multimodal pose editing system 106 utilizes the predicted pose keypoints with the decoder machine learning model to directly generate a dense pose image based on the predicted pose keypoints. In these or other embodiments, the multimodal pose editing system 106 utilizes the decoder machine learning model to generate the dense pose image based on predicted keypoints for any one of (i) estimating a pose of a human in a digital image, (ii) hallucinating a pose of a human not included in a digital image, or (iii) reposing a human in a digital image.

In one or more implementations, the multimodal pose editing system 106 generates a dense pose image utilizing an image-to-image translation method. In particular, the multimodal pose editing system 106 utilizes a deep learning model designed for paired image-to-image translation utilizing conditional generative adversarial networks. For example, the multimodal pose editing system 106 utilizes the deep learning model with the predicted pose keypoints to generate a dense pose image. In these or other embodiments, the multimodal pose editing system 106 generates the dense pose image utilizing the deep learning model based on predicted keypoints for any one of (i) estimating a pose of a human in a digital image, (ii) hallucinating a pose of a human not included in a digital image, or (iii) reposing a human in a digital image.

In some implementations, the multimodal pose editing system 106 curates a large collection of possible pose keypoints, dense pose images, and their corresponding text descriptions. As mentioned above, in some embodiments, the multimodal pose editing system 106 identifies the most likely pose candidates in this collection for the predicted keypoints by comparing keypoint distances. Further, in some implementations, the multimodal pose editing system 106 selects the best candidate pose using text similarity of the pose descriptions.

In one or more embodiments, the multimodal pose editing system 106 acquires a large-scale collection containing pose keypoints, dense pose images, and text descriptions of the pose. This enables the multimodal pose editing system 106 to search for a dense pose image by finding similar keypoint values or pose descriptions. In one or more implementations, to curate this collection, the multimodal pose editing system 106 utilizes 186,000 images of a single human from the dataset for fine-tuning the multimodal large language model (e.g., the multimodal large language model 204). For each image, in some embodiments, the multimodal pose editing system 106 obtains a number of sparse keypoint coordinates (e.g., 33) utilizing a human pose landmark detector, a dense pose image using a pretrain machine learning model (e.g., the DensePose model pretrained on the COCO dataset), and a caption of the person's pose in the image using a pretrained multimodal large language model.

In some implementations, a person could be standing anywhere in a digital image and at any distance away from the camera, meaning that the size and location of possible keypoint coordinates is highly diverse. While this variability is crucial for encompassing the range of plausible human poses in the real world, it also adds a potential difficulty in finding similar poses for the predicted keypoints. For example, if two sets of keypoint coordinates have similar poses but are positioned at opposite sides of the image, then naively computing the distance between keypoints will result in an unintended high value. As a result, in one or more embodiments, the multimodal pose editing system 106 introduces scaling to all keypoints to ensure they have approximately the same location and size, and their differences can be attributed to distinctions in the pose. Specifically, the multimodal pose editing system 106 identifies the bounding box of the keypoints, then scales and shifts this bounding box such that it is centered in the image and such that the height of the bounding box matches the height of the image. In one or more implementations, the multimodal pose editing system 106 utilizes images that are square. For example, the multimodal pose editing system 106 pads images to square using white pixels if they are not originally square.

In some embodiments, to aid in retrieving the dense pose image that best corresponds to the predicted keypoints, the multimodal pose editing system 106 scales the keypoints and compares the predicted keypoint coordinates (e.g., the predicted pose keypoints) with the collection of keypoints (e.g., in the dense pose image database) using nearest neighbors, as measured by the Euclidean distance between each of the individual keypoints (e.g., the 33 keypoints). For pose estimation, in some implementations, the multimodal pose editing system 106 selects the most similar pose entry in the collection based on nearest neighbors. In one or more embodiments, for the pose hallucination and reposing tasks, since a user can optionally specify a text description of their desired pose, if such a text description is provided the multimodal pose editing system 106 initially selects a threshold number (C) of candidate pose entries from the collection based on keypoint similarity. Moreover, in one or more implementations, the multimodal pose editing system 106 compares the text descriptions to choose the candidate pose that best matches the desired pose. This gives more attention to the gender and body shape of the person than keypoints. In some embodiments, the multimodal pose editing system 106 employs the pretrained machine learning model (e.g., the Contrastive Language-Image Pre-training or CLIP model) to extract text embeddings and compute cosine similarity on the embeddings. Furthermore, in some implementations, the multimodal pose editing system 106 selects the dense pose image corresponding to the candidate pose entry that maximizes the text similarity with the desired pose description.

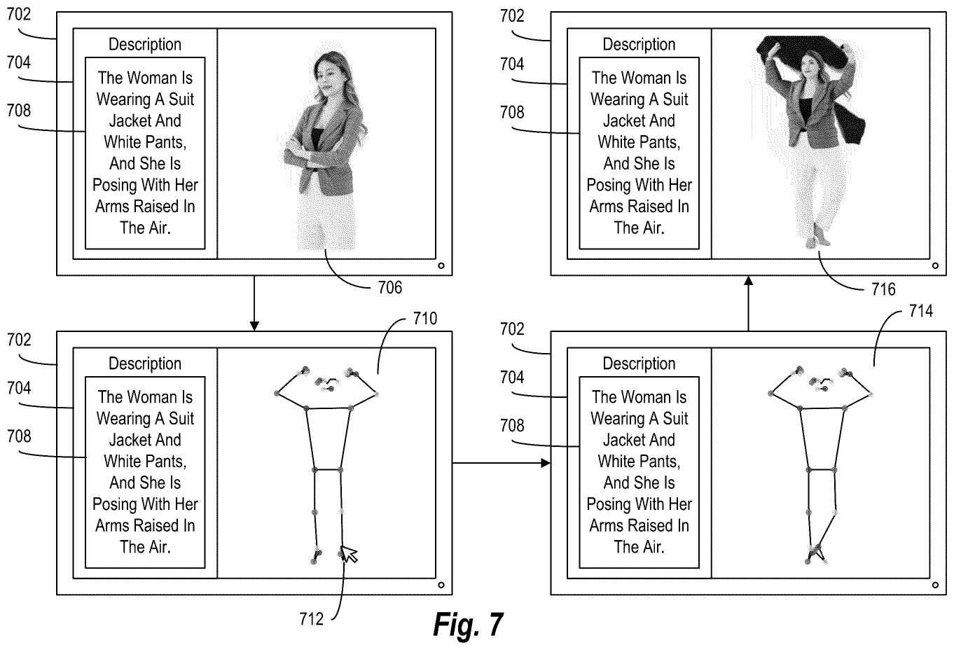

As mentioned above, in some embodiments, the multimodal pose editing system 106 provides a modified digital image for display on a client device a digital image based on an estimated pose of a human, a hallucinated pose of a human, and/or a reposed human. In some implementations, the multimodal pose editing system 106 generates and provides for display on a client device a keypoint representation for modifying keypoints of a pose as part of providing the modified digital image. FIG. 7 illustrates a diagram of the multimodal pose editing system 106 providing for display on a client device a keypoint representation and a modified digital image.

As shown in FIG. 7, in one or more embodiments, the multimodal pose editing system 106 receives digital images and prompt text descriptions via a graphical user interface 704 of a client device 702. Specifically, the multimodal pose editing system 106 receives a digital image 706 and a prompt text description via an interactive description element 708 of the graphical user interface. For example, the multimodal pose editing system 106 receives the digital image 706 and the prompt text description for (i) estimating a pose of a human in a digital image, (ii) hallucinating a pose of a human not included in a digital image, or (iii) reposing a human in a digital image. To illustrate, the multimodal pose editing system 106 receives the digital image 706 with a prompt text description for reposing a woman in the digital image 706 as follows, “the woman is wearing a suit jacket and white pants, and she is posing with her arms raised in the air.”

As further illustrated in FIG. 7, in one or more implementations, the multimodal pose editing system 106 generates and provides a keypoint representation 710 for display via the graphical user interface 704. In particular, the multimodal pose editing system 106 generates the keypoint representation 710 of predicted pose keypoints. For example, the multimodal pose editing system 106 generates and provides the predicted pose keypoints of the keypoint representation 710 to be interactive for editing the locations of the predicted pose keypoints.

As additionally shown in FIG. 7, in some embodiments, the multimodal pose editing system 106 modifies the locations of the predicted pose keypoints in response to a user interaction 712 with the keypoint representation 710. To illustrate, the multimodal pose editing system 106 detects the user interaction 712 indicating to move a predicted pose keypoint corresponding to a position on the lower left leg (e.g., the lower leg, the shin, the ankle, etc.). For example, the user interaction indicates to move the predicted pose keypoint (and connected pose keypoints, e.g., for the left heel, foot, etc.) to a position closer to the right leg of the keypoint representation. Furthermore, in response to detecting the user interaction 712, the multimodal pose editing system 106 generates a modified keypoint representation 714.

As further illustrated in FIG. 7, in some implementations, the multimodal pose editing system 106 generates and provides a modified digital image 716 for display on the client device 702 based on the modified keypoint representation 714. Specifically, the multimodal pose editing system 106 generates the modified digital image 716 based on the pose keypoints of the modified keypoint representation 714 utilizing methods described above with respect to FIGS. 4-6. In this example, the multimodal pose editing system 106 provides the modified digital image 716 reposing the woman in the digital image 706 via the graphical user interface 704.

In one or more embodiments, the multimodal pose editing system 106 does not provide the keypoint representation 710 for display on the client device 702. In particular, the multimodal pose editing system 106 provides the modified digital image 716 based on the multimodal pose editing system 106 receiving the digital image 706 and/or a pose text description. To illustrate, the multimodal pose editing system 106 automatically generates a modified digital image as described above with respect to FIGS. 4-6 and provides the modified digital image for display on the client device 702 in response to receiving the digital image 706 and/or the pose text description.

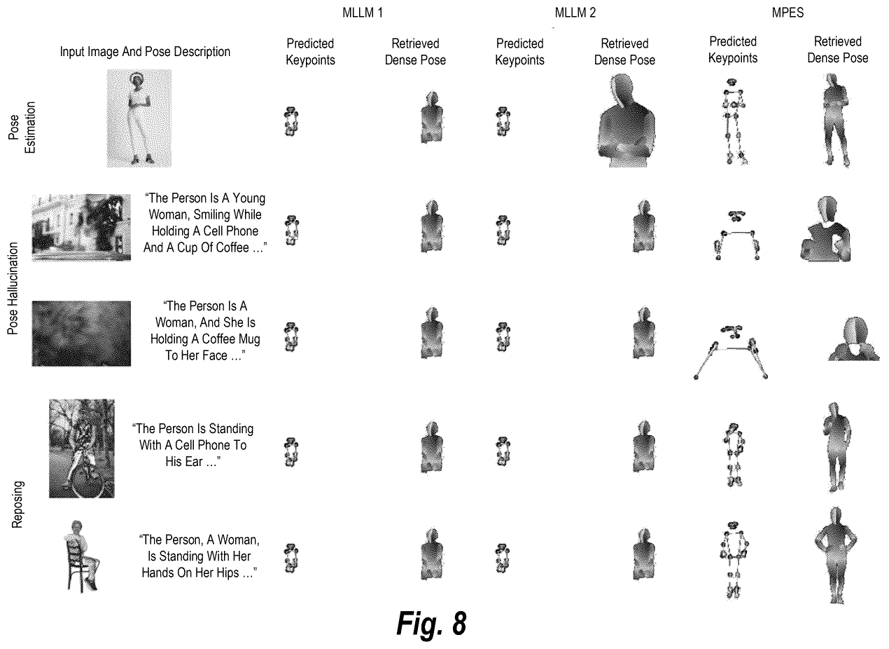

As noted above, in one or more implementations, the multimodal pose editing system 106 improves the flexibility and accuracy of predicting pose keypoints and retrieving dense pose images for generating modified digital images. Indeed, in some embodiments, the multimodal pose editing system 106 improves flexibility and accuracy by utilizing a trained multimodal large language model to generate predicted keypoints and retrieving a corresponding dense pose image based on the predicted pose keypoints. FIG. 8 illustrates predicted pose keypoints and retrieved dense pose image performed by the multimodal pose editing system 106 compared with example prior art predicted pose keypoints and retrieved dense pose images in accordance with one or more embodiments.

As portrayed in FIG. 8, the multimodal pose editing system 106 (MPES) predicts the most accurate pose keypoints and retrieves the most accurate dense pose image for each of the pose estimation, pose hallucination, and reposing tasks. Specifically, the multimodal pose editing system 106 improves pose keypoint prediction and dense pose image retrieval over two multimodal large language models (MLLM 1 and MLLM 2) not trained and integrated with the multimodal pose editing system 106. Indeed, MLLM 1 and MLLM 2 frequently predict identical pose keypoints or pose keypoints with only subtle variations relative to one another, resulting in the same retrieved dense pose image. In contrast, the multimodal pose editing system 106 predicts accurate pose keypoints for many different pose descriptions, including partial-body and full-body poses.

Tables 1, 2A, and 2B illustrate evaluation metrics further indicating the improved flexibility and accuracy of the multimodal pose editing system 106 in predicting pose keypoints and retrieving dense pose images.

TABLE 1

| | Pose Estimation | | Pose Hallucination | | Reposing | |
|---|---|---|---|---|---|---|
| | d ≤ 0.1 | d ≤ 0.2 | d ≤ 0.1 | d ≤ 0.2 | d ≤ 0.1 | d ≤ 0.2 |
| MLLM 1 | 40.16% | 51.92% | 10.54% | 14.65% | 19.53% | 28.72% |
| MLLM 2 | 29.60% | 37.75% | 11.74% | 16.39% | 12.54% | 17.71% |
| MPES | 74.60% | 86.35% | 36.11% | 51.66% | 56.21% | 75.01% |

Table 1 illustrates correct pose keypoints prediction percentages for the multimodal pose editing system 106 (MPES) relative to the two multimodal large language models MLLM 1 and MLLM 2. As indicated by table 1, the multimodal pose editing system 106 predicts pose keypoints much more frequently than either of MLLM 1 or MLLM 2 for each of the pose estimation, pose hallucination, and reposing tasks. In table 1, the predicted keypoints for a pose are “correct” if the distance d=∥kᵢ−\hat{k}ᵢ∥ between the predicted and ground truth pose keypoints does not exceed the threshold. In table 1, the pose keypoint values range between 0 and 1, and 33 keypoints are used per human.

Tables 2A and 2B illustrate evaluation metrics for comparing retrieved dense pose images with actual dense pose images. In particular, tables 2A and 2B illustrate a similarity between contrastive language-image pre-training image embeddings (CLIP Image), a similarity between CLIP text embeddings of image captions (CLIP Text), and a DreamSim distance which measures mid-level perceptual similarity. Tables 2A and 2B indicate that the multimodal pose editing system 106 (MPES) outperforms both MLLM 1 and MLLM 2 using all three evaluation metrics in the pose estimation and reposing tasks. Additionally, the multimodal pose editing system 106 outperforms both MLLM 1 and MLLM 2 using the CLIP Text and DreamSim metrics in the pose hallucination task.

TABLE 2A

| | Pose Estimation | | | Pose Hallucination | | |
|---|---|---|---|---|---|---|
| | CLIP | CLIP | Dream Sim | CLIP | CLIP | DreamSim |
| | Image (↑) | Text (↑) | (↓) | Image (↑) | Text (↑) | (↓) |
| MLLM 1 | 0.888 | 0.498 | 0.225 | 0.893 | 0.481 | 0.239 |
| MLLM 2 | 0.906 | 0.502 | 0.210 | 0.897 | 0.480 | 0.239 |
| MPES | 0.953 | 0.586 | 0.097 | 0.895 | 0.608 | 0.224 |

TABLE 2B

| | Reposing | | |
|---|---|---|---|
| | CLIP | CLIP | DreamSim |
| | Image (↑) | Text (↑) | (↓) |
| MLLM 1 | 0.892 | 0.496 | 0.228 |
| MLLM 2 | 0.877 | 0.472 | 0.246 |
| MPES | 0.932 | 0.769 | 0.142 |

Turning to FIG. 9, additional detail will now be provided regarding various components and capabilities of the multimodal pose editing system 106. In particular, FIG. 9 illustrates an example schematic diagram of a computing device 900 (e.g., the server device(s) 102 and/or the client device(s) 110) implementing the multimodal pose editing system 106 in accordance with one or more embodiments of the present disclosure for components 900-908. As illustrated in FIG. 9, the multimodal pose editing system 106 includes a training manager 902, a multimodal large language model(s) 114, a predicted pose keypoints manager 904, a modified image manager 906, and a storage manager 908.

The training manager 902 trains a multimodal large language model (e.g., the multimodal large language model(s) 114 to perform pose estimation, pose hallucination, and or reposing. Specifically, the training manager 902 generates a large language model prompt including a digital image for use with the multimodal large language model(s) 114. Additionally, the training manager 902 generates a text description of predicted pose keypoints of a human corresponding to the digital image utilizing the large language model prompt and the multimodal large language model(s) 114. Further, the training manager 902 determines a measure of loss by comparing the text description of the predicted pose keypoints with ground truth text tokens of ground truth pose keypoints of the human corresponding to the digital image. Moreover, the multimodal pose editing system 106 modifies the parameters of the multimodal large language model(s) 114 based on the measure of loss.

Furthermore, the predicted pose keypoints manager 904 utilizes the trained multimodal large language model(s) 114 to predict pose keypoints for a human pose. In particular, the predicted pose keypoints manager 904 receives a digital image and an indication to generate a modified digital image from client device. Additionally, the predicted pose keypoints manager 904 utilizes the multimodal large language model(s) 114 to generate a text description of predicted pose keypoints based on the digital image. Further, the predicted pose keypoints manager 904 interacts with other components to pass the predicted pose keypoints for further processing.

Moreover, the modified image manager 906 generates a modified digital image portraying a human utilizing the text description of the predicted pose keypoints. For instance, in some cases the modified image manager 906 generates the modified image directly. In other cases, the modified image manager 906 retrieves or generates a dense pose image based on the predicted pose keypoints and generates the modified image based on the dense pose image. Furthermore, the modified image manager 906 provides the modified image to a client device for display.

Additionally, as shown in FIG. 9, the multimodal pose editing system 106 includes a storage manager 908. In one or more implementations, the storage manager 908 stores information (e.g., via one or more memory devices) on behalf of the multimodal pose editing system 106. For example, the storage manager 908 includes a database for storing digital images pose text descriptions, predicted pose keypoint text descriptions, predicted pose keypoints representations, dense pose images, and/or a dense pose image database.

In some implementations, each of the components 902-908 of the multimodal pose editing system 106 include software, hardware, or both. For example, the components 902-908 include one or more instructions stored on a computer-readable storage medium and executable by processors of one or more computing devices, such as a client device or server device. When executed by the one or more processors, the computer-executable instructions of the multimodal pose editing system 106 cause the computing device(s) to perform the methods described herein. Alternatively, the components 902-908 include hardware, such as a special-purpose processing device to perform a certain function or group of functions. Alternatively, the components 902-908 of the multimodal pose editing system 106 include a combination of computer-executable instructions and hardware.

Furthermore, the components 902-908 of the multimodal pose editing system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 902-908 of the multimodal pose editing system 106 are implemented as a stand-alone application, such as a desktop or mobile application. Furthermore, in various embodiments, the components 902-908 of the multimodal pose editing system 106 are implemented as one or more web-based applications hosted on a remote server. Alternatively, or additionally, the components 902-908 of the multimodal pose editing system 106 are implemented in a suite of mobile device applications or “apps.” For example, in one or more embodiments, the multimodal pose editing system 106 comprises or operates in connection with digital software applications such as ADOBE® CAMERA RAW, ADOBE® FIREFLY®, ADOBE® PHOTOSHOP® CREATIVE CLOUD®, ADOBE® PHOTOSHOP® ELEMENTS, ADOBE® PHOTOSHOP® EXPRESS, ADOBE® PHOTOSHOP® LIGHTROOM®, and/or ADOBE® STOCK.

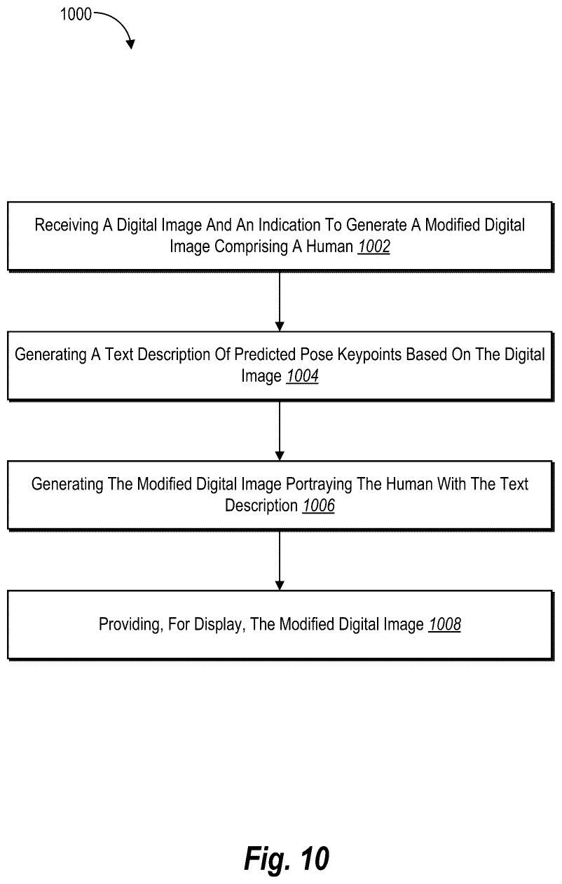

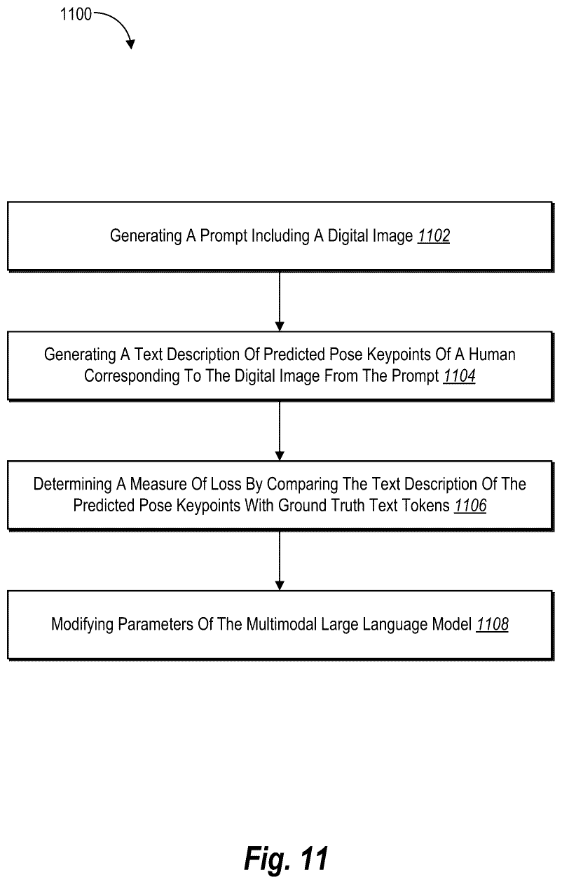

FIGS. 1-9, the corresponding text, and the examples provide a number of different systems, methods, and non-transitory computer readable media for training and implementing a multimodal large language model to estimate a human pose, hallucinate a human pose, and/or repose a human corresponding to a digital image. In addition to the foregoing, embodiments can also be described in terms of flowcharts comprising acts for accomplishing a particular result. For example, FIGS. 10 and 11 illustrate flowcharts of example sequences of acts in accordance with one or more embodiments.

While FIGS. 10 and 11 illustrate acts according to some embodiments, alternative embodiments may omit, add to, reorder, and/or modify any of the acts shown in FIGS. 10 and 11. The acts of FIGS. 10 and 11 can be performed as part of a method. Alternatively, a non-transitory computer readable medium can comprise instructions, that when executed by one or more processors, cause a computing device to perform the acts of FIGS. 10 and 11. In still further embodiments, a system can perform the acts of FIGS. 10 and 11. Additionally, the acts described herein may be repeated or performed in parallel with one another or in parallel with different instances of the same or other similar acts.

FIG. 10 illustrates an example series of acts 1000 for utilizing a multimodal large language model to estimate a human pose, hallucinate a human pose, and/or repose a human corresponding to a digital image. In some embodiments, the series of acts 1000 includes an act 1002 of receiving a digital image and an indication to generate a modified digital image comprising a human; an act 1004 of generating a text description of predicted pose keypoints based on the digital image; an act 1006 of generating the modified digital image portraying the human with the text description; and an act 1008 of providing, for display, the modified digital image.

In some embodiments, the act 1002 includes receiving, from a client device, a digital image and an indication to generate a modified digital image including a human. In some implementations, the act 1004 also includes an act of generating, utilizing a multimodal large language model, a text description of predicted pose keypoints based on the digital image. In one or more embodiments, the act 1006 further includes an act of generating the modified digital image portraying the human utilizing the text description of the predicted pose keypoints. Additionally, in one or more implementations, the act 1008 includes an act of providing, for display, the modified digital image to the client device.

In some implementations, the digital image portrays a first human and further including generating, utilizing the multimodal large language model, the text description of the predicted pose keypoints based on the digital image to estimate a pose of the first human depicted in the digital image. In some embodiments, the series of acts 1000 also includes an act of generating the modified digital image portraying the human by replacing the first human with the human based on the text description of the predicted pose keypoints.

In one or more embodiments, generating, utilizing the multimodal large language model, the text description of the predicted pose keypoints based on the digital image includes generating the text description of the predicted pose keypoints to hallucinate a pose of the human based on a context of the digital image. In one or more implementations, the series of acts 1000 includes receiving a prompt including a text description of the pose. In some implementations, generating the text description of the predicted pose keypoints to hallucinate the pose of the human based on the context of the digital image further includes generating, utilizing the multimodal large language model, the text description of the pose of the human in the modified digital image based on the prompt including the text description of the pose.

In some embodiments, the digital image portrays the human in a first pose and further including receiving a prompt including a text description of a second pose. Additionally, in one or more embodiments, the series of acts 1000 includes an act of generating, utilizing the multimodal large language model, the text description of the predicted pose keypoints from the prompt including the text description of the second pose to repose the human in the modified digital image to the second pose.

In some implementations, generating the modified digital image portraying the human utilizing the text description of the predicted pose keypoints includes selecting, from a dense pose image database including a plurality of dense pose images, a dense pose image based on the text description of the predicted pose keypoints. In one or more implementations, the series of acts 1000 also includes an act of generating the modified digital image using the dense pose image.

In one or more embodiments, selecting, from the dense pose image database, the dense pose image based on the text description of the predicted pose keypoints includes generating, from the text description of the predicted pose keypoints, pose keypoints for the human in the modified digital image. In some embodiments, the series of acts 1000 further includes an act of selecting, utilizing a similarity comparison, the dense pose image from the plurality of dense pose images of the dense pose image database by comparing the pose keypoints to a plurality of pose keypoints corresponding to the plurality of dense pose images.

In one or more implementations, the series of acts 1000 includes receiving a prompt including a text description of a pose of the human in the modified digital image. Additionally, in some implementations, the series of acts 1000 includes an act of generating, utilizing an encoder, a plurality of dense pose text embeddings from text descriptions of the plurality of dense pose images. In one or more embodiments, the series of acts 1000 also includes an act of generating, utilizing the encoder, a text embedding of the text description of the pose of the human. In one or more implementations, the series of acts 1000 further includes an act of selecting the dense pose image from the plurality of dense pose images by comparing the plurality of dense pose text embeddings with the text embedding of the text description of the pose of the human.

In some embodiments, the series of acts 1000 includes receiving a prompt including a text description of a pose. In some embodiments, generating, utilizing the multimodal large language model, the text description of the predicted pose keypoints based on the digital image includes generating the text description of the predicted pose keypoints to hallucinate the pose of the human based on a context of the digital image and the text description of the pose.

In some implementations, the series of acts 1000 includes generating the modified digital image portraying the human utilizing the text description of the predicted pose keypoints includes generating, from the text description of the predicted pose keypoints, pose keypoints for the human in the modified digital image. In some implementations, the series of acts 1000 further includes an act of generating the modified digital image portraying the human from the pose keypoints.

In one or more embodiments, the series of acts 1000 includes generating the modified digital image portraying the human from the pose keypoints includes selecting, from a dense pose image database including a plurality of dense pose images, a subset of dense pose images based on the pose keypoints. Additionally, in one or more embodiments, the series of acts 1000 includes an act of selecting a dense pose image from the subset of dense pose images based on the text description of the predicted pose keypoints. In one or more implementations, the series of acts 1000 also includes an act of generating the modified digital image portraying the human using the selected dense pose image.

In one or more implementations, the series of acts 1000 includes generating, for display in a graphical user interface of the client device, a keypoint representation of the pose keypoints. In some embodiments, the series of acts 1000 further includes an act of modifying, in response to user interaction with the keypoint representation, a location of a pose keypoint of the pose keypoints. Additionally, in some implementations, the series of acts 1000 includes an act of generating the modified digital image portraying the human based on the modified location of the pose keypoint of the pose keypoints.

FIG. 11 illustrates an example series of acts 1100 for training a multimodal large language model to estimate a human pose, hallucinate a human pose, and/or repose a human corresponding to a digital image. In one or more embodiments, the series of acts 1100 includes an act 1102 of generating a prompt including a digital image; an act 1104 of generating a text description of predicted pose keypoints of a human corresponding to the digital image from the prompt; an act 1106 of determining a measure of loss by comparing the text description of the predicted pose keypoints with ground truth text tokens; and an act 1108 of modifying parameters of the multimodal large language model.

In some embodiments, the act 1102 includes generating a large language model prompt including a digital image. Additionally, in one or more implementations, the act 1104 includes an act of generating, utilizing a multimodal large language model, a text description of predicted pose keypoints of a human corresponding to the digital image from the prompt. In some embodiments, the act 1106 also includes an act of determining a measure of loss by comparing the text description of the predicted pose keypoints with ground truth text tokens of ground truth pose keypoints of the human. In some implementations, the act 1108 further includes an act of modifying parameters of the multimodal large language model based on the measure of loss.

In some implementations, the digital image portrays a first human and the series of acts 1100 further includes training the multimodal large language model on a pose prediction training task by generating, utilizing the multimodal large language model, the text description of the predicted pose keypoints to estimate a pose of the first human in the digital image. Additionally, in one or more embodiments, the series of acts 1100 includes an act of determining the measure of loss by comparing the text description of the predicted pose keypoints estimating the pose of the first human with the ground truth text tokens of the ground truth pose keypoints, wherein the ground truth pose keypoints represent the pose of the first human in the digital image.

In one or more embodiments, the digital image portrays the human and the series of acts 1100 further includes training the multimodal large language model on a pose hallucination training task by generating, utilizing the multimodal large language model, the text description of the predicted pose keypoints to hallucinate a pose of the human based on a context of the digital image. In one or more implementations, the series of acts 1100 includes training the multimodal large language model on the pose hallucination training task by generating a masked digital image by masking the human depicted in the digital image. In one or more implementations, the series of acts 1100 also includes an act of generating, utilizing the multimodal large language model, the text description of the predicted pose keypoints of the human utilizing the masked digital image. In some embodiments, the series of acts 1100 further includes an act of determining the measure of loss by comparing the text description of the predicted pose keypoints with the ground truth text tokens of the ground truth pose keypoints of the human.

In some embodiments, the digital image portrays the human and the series of acts 1100 further includes training the multimodal large language model on a reposing training task by generating, utilizing the multimodal large language model, the text description of the predicted pose keypoints to repose the human from a first pose to a second pose. Additionally, in some implementations, the series of acts 1100 includes an act of determining the measure of loss by comparing the text description of the predicted pose keypoints reposing the human from the first pose to the second pose with the ground truth text tokens of the ground truth pose keypoints, wherein the ground truth pose keypoints represent the human in the second pose.

In some implementations, the series of acts 1100 includes modifying the parameters of the multimodal large language model based on a pose prediction training task and at least one of a hallucination training task or a reposing training task. In one or more embodiments, the series of acts 1100 includes modifying the parameters of the multimodal large language model based on a hallucination training task and a reposing training task.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 12 illustrates, in block diagram form, an example computing device 1200 (e.g., the computing device 900, the client device(s) 110, and/or the server device(s) 102) that may be configured to perform one or more of the processes described above. As shown by FIG. 12, the computing device can comprise a processor(s) 1202, memory 1204, a storage device 1206, an I/O interface 1208, and a communication interface 1210.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them. The computing device 1200 includes memory 1204, which is coupled to the processor(s) 1202. The memory 1204 may be used for storing data, metadata, and programs for execution by the processor(s). The memory 1204 may include one or more of volatile and non-volatile memories. The memory 1204 may be internal or distributed memory. The computing device 1200 includes a storage device 1206 includes storage for storing data or instructions. As an example, and not by way of limitation, storage device 1206 can comprise a non-transitory storage medium described above. The computing device 1200 also includes one or more input or output (“I/O”) devices/interfaces 1208, which are provided to allow a user to provide input to (such as user strokes), receive output from, and otherwise transfer data to and from the computing device 1200. These I/O devices/interfaces 1208 may include a mouse, keypad or a keyboard, a touch screen, camera, optical scanner, network interface, modem, other known I/O devices or a combination of such I/O devices/interfaces 1208.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices (e.g., computing device 1200) or one or more networks. The computing device 1200 can further include a bus 1212. The bus 1212 can comprise hardware, software, or both that couples components of computing device 1200 to each other.

What is claimed is:

1. A computer-implemented method comprising:
receiving, from a client device, a digital image and an indication to generate a modified digital image comprising a human;
generating, utilizing a multimodal large language model, a text description of predicted pose keypoints based on the digital image;
generating the modified digital image portraying the human utilizing the text description of the predicted pose keypoints; and
providing, for display, the modified digital image to the client device.

2. The computer-implemented method of claim 1, wherein the digital image portrays a first human and further comprising:
generating, utilizing the multimodal large language model, the text description of the predicted pose keypoints based on the digital image to estimate a pose of the first human depicted in the digital image; and
generating the modified digital image portraying the human by replacing the first human with the human based on the text description of the predicted pose keypoints.

3. The computer-implemented method of claim 1, wherein generating, utilizing the multimodal large language model, the text description of the predicted pose keypoints based on the digital image comprises generating the text description of the predicted pose keypoints to hallucinate a pose of the human based on a context of the digital image.

4. The computer-implemented method of claim 3, further comprising:
receiving a prompt comprising a text description of the pose; and
wherein generating the text description of the predicted pose keypoints to hallucinate the pose of the human based on the context of the digital image further comprises generating, utilizing the multimodal large language model, the text description of the pose of the human in the modified digital image based on the prompt comprising the text description of the pose.

5. The computer-implemented method of claim 1, wherein the digital image portrays the human in a first pose and further comprising:
receiving a prompt comprising a text description of a second pose;
generating, utilizing the multimodal large language model, the text description of the predicted pose keypoints from the prompt comprising the text description of the second pose to repose the human in the modified digital image to the second pose.

6. The computer-implemented method of claim 1, wherein generating the modified digital image portraying the human utilizing the text description of the predicted pose keypoints comprises:
selecting, from a dense pose image database comprising a plurality of dense pose images, a dense pose image based on the text description of the predicted pose keypoints; and
generating the modified digital image using the dense pose image.

7. The computer-implemented method of claim 6, wherein selecting, from the dense pose image database, the dense pose image based on the text description of the predicted pose keypoints comprises:
generating, from the text description of the predicted pose keypoints, pose keypoints for the human in the modified digital image; and
selecting, utilizing a similarity comparison, the dense pose image from the plurality of dense pose images of the dense pose image database by comparing the pose keypoints to a plurality of pose keypoints corresponding to the plurality of dense pose images.

8. The computer-implemented method of claim 6, further comprising:
receiving a prompt comprising a text description of a pose of the human in the modified digital image; and
generating, utilizing an encoder, a plurality of dense pose text embeddings from text descriptions of the plurality of dense pose images;
generating, utilizing the encoder, a text embedding of the text description of the pose of the human; and
selecting the dense pose image from the plurality of dense pose images by comparing the plurality of dense pose text embeddings with the text embedding of the text description of the pose of the human.

9. A system comprising:
one or more memory devices; and
one or more processing devices coupled to the one or more memory devices that cause the system to perform operations comprising:
generating a large language model prompt comprising a digital image;
generating, utilizing a multimodal large language model, a text description of predicted pose keypoints of a human corresponding to the digital image from the prompt;
determining a measure of loss by comparing the text description of the predicted pose keypoints with ground truth text tokens of ground truth pose keypoints of the human; and
modifying parameters of the multimodal large language model based on the measure of loss.

10. The system of claim 9, wherein the digital image portrays a first human and wherein the one or more processing devices are further configured to train the multimodal large language model on a pose prediction training task by:
generating, utilizing the multimodal large language model, the text description of the predicted pose keypoints to estimate a pose of the first human in the digital image; and
determining the measure of loss by comparing the text description of the predicted pose keypoints estimating the pose of the first human with the ground truth text tokens of the ground truth pose keypoints, wherein the ground truth pose keypoints represent the pose of the first human in the digital image.

11. The system of claim 9, wherein the digital image portrays the human and wherein the one or more processing devices are further configured to train the multimodal large language model on a pose hallucination training task by generating, utilizing the multimodal large language model, the text description of the predicted pose keypoints to hallucinate a pose of the human based on a context of the digital image.

12. The system of claim 11, wherein the one or more processing devices are further configured to train the multimodal large language model on the pose hallucination training task by:
generating a masked digital image by masking the human depicted in the digital image;
generating, utilizing the multimodal large language model, the text description of the predicted pose keypoints of the human utilizing the masked digital image; and
determining the measure of loss by comparing the text description of the predicted pose keypoints with the ground truth text tokens of the ground truth pose keypoints of the human.

13. The system of claim 9, wherein the digital image portrays the human and wherein the one or more processing devices are further configured to train the multimodal large language model on a reposing training task by:
generating, utilizing the multimodal large language model, the text description of the predicted pose keypoints to repose the human from a first pose to a second pose; and
determining the measure of loss by comparing the text description of the predicted pose keypoints reposing the human from the first pose to the second pose with the ground truth text tokens of the ground truth pose keypoints, wherein the ground truth pose keypoints represent the human in the second pose.

14. The system of claim 9, wherein the one or more processing devices are further configured to modify the parameters of the multimodal large language model based on a pose prediction training task and at least one of: a hallucination training task or a reposing training task.

15. The system of claim 9, wherein the one or more processing devices are further configured to modify the parameters of the multimodal large language model based on a hallucination training task and a reposing training task.

16. A non-transitory computer-readable medium storing instructions thereon that, when executed by at least one processing device, cause the at least one processing device to perform operations comprising:
receiving, from a client device, a digital image and an indication to generate a modified digital image comprising a human;
generating, utilizing a multimodal large language model, a text description of predicted pose keypoints based on the digital image;
generating the modified digital image portraying the human utilizing the text description of the predicted pose keypoints; and
providing, for display, the modified digital image to the client device.

17. The non-transitory computer-readable medium of claim 16, wherein the operations further comprise:
receiving a prompt comprising a text description of a pose; and
wherein generating, utilizing the multimodal large language model, the text description of the predicted pose keypoints based on the digital image comprises generating the text description of the predicted pose keypoints to hallucinate the pose of the human based on a context of the digital image and the text description of the pose.

18. The non-transitory computer-readable medium of claim 16, wherein generating the modified digital image portraying the human utilizing the text description of the predicted pose keypoints comprises:
generating, from the text description of the predicted pose keypoints, pose keypoints for the human in the modified digital image; and
generating the modified digital image portraying the human from the pose keypoints.

19. The non-transitory computer-readable medium of claim 18, wherein generating the modified digital image portraying the human from the pose keypoints comprises:
selecting, from a dense pose image database comprising a plurality of dense pose images, a subset of dense pose images based on the pose keypoints;
selecting a dense pose image from the subset of dense pose images based on the text description of the predicted pose keypoints; and
generating the modified digital image portraying the human using the selected dense pose image.

20. The non-transitory computer-readable medium of claim 18, wherein the operations further comprise:
generating, for display in a graphical user interface of the client device, a keypoint representation of the pose keypoints;
modifying, in response to user interaction with the keypoint representation, a location of a pose keypoint of the pose keypoints; and
generating the modified digital image portraying the human based on the modified location of the pose keypoint of the pose keypoints.
